(19) United States
(12) Patent Application Publication
(10) Pub. No.: US 2024/0388941 A1
(43) Pub. Date: Nov. 21, 2024

(54) CROSS LINK INTERFERENCE (CLI) MEASUREMENT IN SUBBAND FULL-DUPLEX (SBFD) OPERATION

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Qian ZHANG, Basking Ridge, NJ (US)

(21) Appl. No.: 18/661,463

(22) Filed: May 10, 2024

Related U.S. Application Data
(60) Provisional application No. 63/503,460, filed on May 19, 2023.

(51) Int. Cl. H04W 24/10; H04B 17/345; H04L 5/14

(52) U.S. Cl. CPC H04W 24/10; H04B 17/345; H04L 5/14

(57) ABSTRACT

Methods, systems, and devices for wireless communication are described. A wireless communications system may employ subband full-duplex (SBFD). In SBFD resources, a first user equipment (UE) may experience cross link interference (CLI) from a second UE if the second UE transmits using a frequency that is similar to a frequency of the subbands used by the first UE. The network may configure a CLI measurement resource in an SBFD time resource and may indicate in which subbands to measure CLI. The network may also indicate the reporting quantities (e.g., whether to report CLI measurement information per subband or combined per communication direction). CLI measurements may be generated in a subband manner. A CLI measurement for a CLI subband that overlaps with different subbands may be generated for the uplink subband only, may be generated for both the uplink subband and the guard band, or may be skipped.

### CROSS REFERENCE

The present application for patent claims the benefit of U.S. Provisional Patent Application No. 63/503,460 by ABDELGHAFFAR et al., entitled “CROSS LINK INTERFERENCE (CLI) MEASUREMENT IN SUBBAND FULL-DUPLEX (SBFD) OPERATION,” filed May 19, 2023, and assigned to the assignee hereof. U.S. Provisional Patent Application No. 63/503,460 is expressly incorporated by reference herein in its entirety.

### INTRODUCTION

The following relates to wireless communications that pertain to cross link interference (CLI) measurement in subband full-duplex (SBFD) operation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support cross link interference (CLI) measurement in subband full-duplex (SBFD) operation. For example, the described techniques provide for the configuration of CLI measurement resources and reporting in SBFD time resources (e.g., SBFD slots or symbols). Some wireless communications systems may employ SBFD according to which: a user equipment (UE) may transmit and a network entity may receive via a first set of one or more subbands (which may be referred to as uplink subbands); and a UE may receive and the network entity may transmit via a second set of one or more subbands (which may be referred to as downlink subbands). In SBFD time resources, a first UE may experience CLI from a second UE if the second UE transmits using a frequency that is similar to a frequency of the uplink subbands or the downlink subbands, or both, used by the first UE. The network may configure a CLI measurement resource for a UE measurement in an SBFD symbol or slot (e.g., an SBFD time resource). The network may indicate, for the CLI measurement resource, in which bands to measure CLI. For example, the network may indicate to measure CLI in: the downlink subbands; the downlink subbands and guard bands; the uplink subband; the uplink subband and guard bands; or the downlink subbands, guard bands, and the uplink subbands. The network may also indicate the reporting quantities, for example, whether to report the CLI measurement information separately for each subband or to combine the CLI measurements based on communication direction. In some aspects, CLI measurements may be generated and reported in a subband manner, meaning that the CLI measurement resource is separated into sets of frequency resources. In some aspects, some of the sets may overlap with different subbands of the SBFD time resource. A CLI measurement for a CLI subband that overlaps with different subbands may be generated for the uplink subband only, may be generated for both the uplink subband and the guard band, or may be skipped.

A method for wireless communication at a first network entity is described. The method may include receiving, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration, generating, using a portion of the set of frequency resources that overlaps with a downlink bandwidth part for the first network entity, CLI measurement information, and transmitting, to the second network entity, a first report indicative of the CLI measurement information, where the first report is in accordance with the CLI report configuration.

A first network entity for wireless communication is described. The first network entity may include a communication interface; and at least one processor coupled to the communication interface. The first network entity is configured to receive, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration, generate, using a portion of the set of frequency resources that overlaps with a downlink bandwidth part for the first network entity, CLI measurement information, and transmit, to the second network entity, a first report indicative of the CLI measurement information, where the first report is in accordance with the CLI report configuration.

Another apparatus for wireless communication at a first network entity is described. The apparatus may include means for receiving, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration, means for generating, using a portion of the set of frequency resources that overlaps with a downlink bandwidth part for the first network entity, CLI measurement information, and means for transmitting, to the second network entity, a first report indicative of the CLI measurement information, where the first report is in accordance with the CLI report configuration.

A non-transitory computer-readable having code for wireless communication stored thereon is described. The code, when executed by a first network entity, causes the first network entity to receive, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration, generate, using a portion of the set of frequency resources that overlaps with a downlink bandwidth part for the first network entity, CLI measurement information, and transmit, to the second network entity, a first report indicative of the CLI measurement information, where the first report is in accordance with the CLI report configuration.

In some examples of the method, apparatuses, and non-transitory computer-readable medium described herein, the CLI measurement resource spans the set of multiple frequency resources of the SBFD time resource and the one or more types of information includes one or more CLI received signal strength indicator (RSSI) values.

In some examples of the method, apparatuses, and non-transitory computer-readable medium described herein, the set of frequency resources may be the first downlink subband and the second downlink subband and the one or more types of information includes a single CLI RSSI value that may be an average of the CLI measurement information generated for the first downlink subband and the second downlink subband that overlap with the downlink bandwidth part for the first network entity.

In some examples of the method, apparatuses, and non-transitory computer-readable medium described herein, the set of frequency resources may be the first downlink subband and the second downlink subband and the one or more types of information includes the CLI measurement information that overlaps with the DL BWP for the first network entity on a per-downlink subband basis.

In some examples of the method, apparatuses, and non-transitory computer-readable medium described herein, the set of frequency resources may be the first downlink subband, a second downlink subband included in the plurality of frequency resources and separated from the uplink resource by a second guard band, the first guard band, and the second guard band and the one or more types of information includes a single CLI RSSI value that may be an average of the CLI measurement information generated for the first downlink subband, the second downlink subband, the first guard band, and the second guard band.

In some examples of the method, apparatuses, and non-transitory computer-readable medium described herein, the set of frequency resources may be the first downlink subband, a second downlink subband included in the plurality of frequency resources and separated from the uplink resource by a second guard band, the first guard band, and the second guard band and the one or more types of information includes a first CLI RSSI value generated for the first downlink subband and the first guard band and a second CLI RSSI value generated for the second downlink subband and the second guard band.

In some examples of the method, apparatuses, and non-transitory computer-readable medium described herein, the set of frequency resources may be the first downlink subband, the second downlink subband, and the uplink subband and the one or more types of information includes the CLI measurement information on a per-downlink subband or uplink subband basis.

In some examples of the method, apparatuses, and non-transitory computer-readable medium described herein, the set of frequency resources may be the first downlink subband, the second downlink subband, and the uplink subband and the one or more types of information includes a first CLI RSSI value that may be an average of the CLI measurement information generated for the first downlink subband and the second downlink subband and a second CLI RSSI value generated for the uplink subband.

In some examples of the method, apparatuses, and non-transitory computer-readable medium described herein, the set of frequency resources may be the first downlink subband, the second downlink subband, the uplink subband, the first guard band, and the second guard band and the one or more types of information includes a first CLI RSSI value that may be an average of the CLI measurement information generated for the first downlink subband and the second downlink subband, a second CLI RSSI value generated for the uplink subband, and a third CLI RSSI value that may be an average of the CLI measurement information generated for the first guard band and the second guard band.

In some examples of the method, apparatuses, and non-transitory computer-readable medium described herein, the set of frequency resources may be the first downlink subband, the second downlink subband, the uplink subband, the first guard band, and the second guard band and the one or more types of information includes the CLI measurement information on a per-downlink subband basis, a per-uplink subband basis, and a per guard band basis.

In some examples of the method, apparatuses, and non-transitory computer-readable medium described herein, receiving the control information may include operations, features, means, or instructions for receiving an index indicative of a combination of the set of frequency resources and the CLI report configuration.

In some examples of the method, apparatuses, and non-transitory computer-readable medium described herein, receiving the control information may include operations, features, means, or instructions for receiving a CLI report configuration, wherein the control information is included in the CLI report configuration.

In some examples of the method, apparatuses, and non-transitory computer-readable medium described herein, the CLI measurement resource spans the set of multiple frequency resources of the SBFD time resource, the CLI report configuration may be for a reporting subband that at least partially overlaps with the first downlink subband, wherein the reporting subband is one or a plurality of CLI measurement subbands that overlap the plurality of frequency resources, and the one or more types of information includes a CLI RSSI value.

In some examples of the method, apparatuses, and non-transitory computer-readable medium described herein, generating the CLI measurement information may include operations, features, means, or instructions for measuring CLI within only a portion of the reporting subband that overlaps with the first downlink subband.

In some examples of the method, apparatuses, and non-transitory computer-readable medium described herein, generating the CLI measurement information may include operations, features, means, or instructions for measuring CLI within only a portion of the reporting subband that overlaps with the first downlink subband and the first guard band.

In some examples of the method, apparatuses, and non-transitory computer-readable medium described herein, the CLI measurement resource spans the uplink subband and the first guard band, the CLI measurement information pertains to measurements of only the uplink subband, the one or more types of information includes a CLI reference signal received power (RSRP) value or an RSSI value, and the RSRP value or the RSSI value may be associated with the measurements of only the uplink subband.

In some examples of the method, apparatuses, and non-transitory computer-readable medium described herein, the CLI measurement resource spans the uplink subband and the first guard band, the CLI measurement information pertains to measurements of the uplink subband and the first guard band, the one or more types of information includes a CLI RSRP value or an RSSI value, and the RSRP value or the RSSI value may be associated with the measurements of the uplink subband, the first guard band, and the second guard band.

In some examples of the method, apparatuses, and non-transitory computer-readable medium described herein, the CLI measurement resource spans the uplink subband and the first guard band, the CLI measurement information pertains to measurements of the uplink subband and at least a first portion of the first guard band and a second portion of the second guard band, the uplink subband and at least the first portion of the first guard band may be associated with a sounding reference signal sequence, and the one or more types of information includes a CLI RSRP value or an RSSI value, and the RSRP value or the RSSI value may be associated with the measurements of the uplink subband and at least the first portion of the first guard band.

In some examples of the method, apparatuses, and non-transitory computer-readable medium described herein, the CLI measurement resource spans the uplink subband and at least the first guard band, the one or more types of information includes a CLI RSRP value or an include value, and the RSRP value or the RSSI value may be associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

In some examples of the method, apparatuses, and non-transitory computer-readable medium described herein, the CLI measurement resource spans the uplink subband and at least the first guard band, the one or more types of information includes a CLI RSRP value an RSSI value, and the RSRP value or the RSSI value may be associated with measurements of only a portion of a reporting subband that overlaps with the uplink subband and at least the first guard band.

In some examples of the method, apparatuses, and non-transitory computer-readable medium described herein, the CLI measurement resource corresponds to a set of multiple sounding reference signal (SRS) hopping occasions within the uplink subband, the one or more types of information includes one or more CLI RSRP values or one or more RSSI values, and each of the one or more RSRP values may be associated with measurements of a respective reporting subband that overlaps with a corresponding one of the set of multiple SRS hopping occasions.

In some examples of the method, apparatuses, and non-transitory computer-readable medium described herein, the one or more types of information includes a single RSRP value or RSSI value for a most recent one of the set of multiple SRS hopping occasions.

In some examples of the method, apparatuses, and non-transitory computer-readable medium described herein, the one or include types of information includes a set of multiple RSRP values, each of the set of multiple RSRP values associated with a respective one of the set of multiple SRS hopping occasions.

A method for wireless communication at a first network entity is described. The method may include transmitting, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration and receiving, from the second network entity, a first report indicative of CLI measurement information associated with the set of frequency resources in accordance with the CLI report configuration.

A first network entity for wireless communication is described. The first network entity may include a communication interface; and at least one processor coupled to the communication interface. The first network entity is configured to transmit, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration and receive, from the second network entity, a first report indicative of CLI measurement information associated with the set of frequency resources in accordance with the CLI report configuration.

Another apparatus for wireless communication at a first network entity is described. The apparatus may include means for transmitting, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration and means for receiving, from the second network entity, a first report indicative of CLI measurement information associated with the set of frequency resources in accordance with the CLI report configuration.

A non-transitory computer-readable having code for wireless communication stored thereon is described. The code, when executed by a first network entity, causes the first network entity to transmit, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration and receive, from the second network entity, a first report indicative of CLI measurement information associated with the set of frequency resources in accordance with the CLI report configuration.

In some examples of the method, apparatuses, and non-transitory computer-readable medium described herein, the CLI measurement resource spans the set of multiple frequency resources of the SBFD time resource and the one or more types of information includes one or more CLI RSSI values.

In some examples of the method, apparatuses, and non-transitory computer-readable medium described herein, the set of frequency resources may be the first downlink subband and the second downlink subband and the one or more types of information includes a single CLI RSSI value that may be an average of the CLI measurement information generated for the first downlink subband and the second downlink subband that overlap with the downlink bandwidth part for the first network entity.

In some examples of the method, apparatuses, and non-transitory computer-readable medium described herein, the set of frequency resources may be the first downlink subband and the second downlink subband and the one or more types of information includes the CLI measurement information that overlaps with the BWP for the first network entity on a per-downlink subband basis.

In some examples of the method, apparatuses, and non-transitory computer-readable medium described herein, the set of frequency resources may be the first downlink subband, a second downlink subband included in the plurality of frequency resources and separated from the uplink resource by a second guard band, the first guard band, and the second guard band and the one or more types of information includes a single CLI RSSI value that may be an average of the CLI measurement information generated for the first downlink subband, the second downlink subband, the first guard band, and the second guard band.

In some examples of the method, apparatuses, and non-transitory computer-readable medium described herein, the set of frequency resources may be the first downlink subband, a second downlink subband included in the plurality of frequency resources and separated from the uplink resource by a second guard band, the first guard band, and the second guard band and the one or more types of information includes a first CLI RSSI value generated for the first downlink subband and the first guard band and a second CLI RSSI value generated for the second downlink subband and the second guard band.

In some examples of the method, apparatuses, and non-transitory computer-readable medium described herein, the set of frequency resources may be the first downlink subband, the second downlink subband, and the uplink subband and the one or more types of information includes the CLI measurement information on a per-downlink subband or uplink subband basis.

In some examples of the method, apparatuses, and non-transitory computer-readable medium described herein, the set of frequency resources may be the first downlink subband, the second downlink subband, and the uplink subband and the one or more types of information includes a first CLI RSSI value that may be an average of the CLI measurement information generated for the first downlink subband and the second downlink subband and a second CLI RSSI value generated for the uplink subband.

In some examples of the method, apparatuses, and non-transitory computer-readable medium described herein, the set of frequency resources may be the first downlink subband, the second downlink subband, the uplink subband, the first guard band, and the second guard band and the one or more types of information includes a first CLI RSSI value that may be an average of the CLI measurement information generated for the first downlink subband and the second downlink subband, a second CLI RSSI value generated for the uplink subband, and a third CLI RSSI value that may be an average of the CLI measurement information generated for the first guard band and the second guard band.

In some examples of the method, apparatuses, and non-transitory computer-readable medium described herein, the set of frequency resources may be the first downlink subband, the second downlink subband, the uplink subband, the first guard band, and the second guard band and the one or more types of information includes the CLI measurement information on a per-downlink subband basis, a per-uplink subband basis, and a per guard band basis.

In some examples of the method, apparatuses, and non-transitory computer-readable medium described herein, transmitting the control information may include operations, features, means, or instructions for transmitting an index indicative of a combination of the set of frequency resources and the CLI report configuration.

In some examples of the method, apparatuses, and non-transitory computer-readable medium described herein, transmitting the control information may include operations, features, means, or instructions for transmitting a cross link interference report configuration, where the control information is included in the cross link interference report configuration.

In some examples of the method, apparatuses, and non-transitory computer-readable medium described herein, the CLI measurement resource spans the set of multiple frequency resources of the SBFD time resource, the CLI report configuration may be for a reporting subband that at least partially overlaps with the first downlink subband, wherein the reporting subband is one or a plurality of CLI measurement subbands that overlap the plurality of frequency resources, and the one or more types of information includes a CLI RSSI value.

In some examples of the method, apparatuses, and non-transitory computer-readable medium described herein, the CLI report configuration indicates that only a portion of the reporting subband that overlaps with the one of the first downlink subband or the second downlink subband may be to be included in the CLI report that may be in accordance with the CLI report configuration.

In some examples of the method, apparatuses, and non-transitory computer-readable medium described herein, the CLI report configuration indicates that only a portion of the reporting subband that overlaps with the one of the first downlink subband or the second downlink subband and any of the first guard band or the second guard band may be to be included in the CLI report that may be in accordance with the CLI report configuration.

In some examples of the method, apparatuses, and non-transitory computer-readable medium described herein, the CLI measurement resource spans the uplink subband and the first guard band, the CLI measurement information pertains to measurements of only the uplink subband, the one or more types of information includes a CLI RSRP value or an RSSI value, and the RSRP value or the RSSI value may be associated with the measurements of only the uplink subband.

In some examples of the method, apparatuses, and non-transitory computer-readable medium described herein, the CLI measurement resource spans the uplink subband and the first guard band, the CLI measurement information pertains to measurements of the uplink subband and the first guard band, the one or more types of information includes a CLI RSRP value or an RSSI value, and the RSRP value or the RSSI value may be associated with the measurements of the uplink subband, the first guard band, and the second guard band.

In some examples of the method, apparatuses, and non-transitory computer-readable medium described herein, the CLI measurement resource spans the uplink subband and the first guard band, the CLI measurement information pertains to measurements of the uplink subband and at least a first portion of the first guard band and a second portion of the second guard band, the uplink subband and at least the first portion of the first guard band may be associated with a sounding reference signal sequence, the one or more types of information includes a CLI RSRP value or an RSSI value, and the RSRP value or the RSSI value may be associated with the measurements of the uplink subband and at least the first portion of the first guard band.

In some examples of the method, apparatuses, and non-transitory computer-readable medium described herein, the CLI measurement resource spans the uplink subband and at least the first guard band, the one or more types of information includes a CLI RSRP value or an RSSI value, and the RSRP value or the RSSI value may be associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

In some examples of the method, apparatuses, and non-transitory computer-readable medium described herein, the CLI measurement resource spans the uplink subband and at least the first guard band, the one or more types of information includes a CLI RSRP value or an RSSI value, and RSRPRSRP value or the RSSI value may be associated with measurements of only a portion of a reporting subband that overlaps with the uplink subband and at least the first guard band.

In some examples of the method, apparatuses, and non-transitory computer-readable medium described herein, the CLI measurement resource corresponds to a set of multiple SRS hopping occasions within the uplink subband, the one or more types of information includes one or more CLI RSRP values, and each of the one or more RSRP values may be associated with measurements of a respective reporting subband that overlaps with a corresponding one of the set of multiple SRS hopping occasions.

In some examples of the method, apparatuses, and non-transitory computer-readable medium described herein, the one or more types of information includes a single RSRP value or RSSI value for a most recent one of the set of multiple SRS hopping occasions.

In some examples of the method, apparatuses, and non-transitory computer-readable medium described herein, the one or more types of information includes a set of multiple RSRP values or RSSI values, each of the set of multiple RSRP values or RSSI values associated with a respective one of the set of multiple SRS hopping occasions.

### BRIEF DESCRIPTION OF THE DRAWINGS

FIG. 1 shows an example of a wireless communications system that supports cross link interference (CLI) measurement in subband full-duplex (SBFD) operation in accordance with one or more aspects of the present disclosure.

FIG. 2 shows an example of a wireless communications system that supports CLI measurement in SBFD operation in accordance with one or more aspects of the present disclosure.

FIG. 3 shows an example of a resource diagram that supports CLI measurement in SBFD operation in accordance with one or more aspects of the present disclosure.

FIG. 4 shows an example of a resource diagram that supports CLI measurement in SBFD operation in accordance with one or more aspects of the present disclosure.

FIG. 5 shows an example of a resource diagram that supports CLI measurement in SBFD operation in accordance with one or more aspects of the present disclosure.

FIG. 6 shows an example of a resource diagram that supports CLI measurement in SBFD operation in accordance with one or more aspects of the present disclosure.

FIG. 7 shows an example of a resource diagram that supports CLI measurement in SBFD operation in accordance with one or more aspects of the present disclosure.

FIG. 8 shows an example of a process flow that supports CLI measurement in SBFD operation in accordance with one or more aspects of the present disclosure.

FIGS. 9 and 10 show block diagrams of devices that support CLI measurement in SBFD operation in accordance with one or more aspects of the present disclosure.

FIG. 11 shows a block diagram of a communications manager that supports CLI measurement in SBFD operation in accordance with one or more aspects of the present disclosure.

FIG. 12 shows a diagram of a system including a device that supports CLI measurement in SBFD operation in accordance with one or more aspects of the present disclosure.

FIGS. 13 and 14 show block diagrams of devices that support CLI measurement in SBFD operation in accordance with one or more aspects of the present disclosure.

FIG. 15 shows a block diagram of a communications manager that supports CLI measurement in SBFD operation in accordance with one or more aspects of the present disclosure.

FIG. 16 shows a diagram of a system including a device that supports CLI measurement in SBFD operation in accordance with one or more aspects of the present disclosure.

FIGS. 17 and 18 show flowcharts illustrating methods that support CLI measurement in SBFD operation in accordance with one or more aspects of the present disclosure.

### DETAILED DESCRIPTION

A wireless communications system may implement full-duplex communication according to which network devices may simultaneously transmit and receive. In some deployments, a full-duplex capable network device (e.g., a network entity) may employ subband full-duplex (SBFD) according to which the network device may receive via a first set of one or more subbands (which may be referred to as uplink subbands) and transmit via a second set of one or more subbands (which may be referred to as downlink subbands), where the first and second sets of subbands may be non-overlapping in the frequency domain. The uplink subbands and the downlink subbands may be separated by guard bands. Some user equipments (UEs) may similarly be capable of full duplex communication and may employ SBFD. Some half-duplex UEs may be SBFD aware, meaning that the network indicates the uplink and downlink subbands to the UE, though the UE can either transmit or receive in a same time resource. In SBFD time resources, a first UE may experience cross link interference (CLI) from a second UE if the second UE transmits using a frequency that is similar to a frequency of the uplink subbands or the downlink subbands, or both, used by the first UE. In some SBFD deployments (such as those in which the first UE and the second UE may use a same uplink subband), CLI in the uplink subband and the guard bands may affect communication performance, as intra-subband CLI may impact a receiver dynamic range and/or a receiver automatic gain control (AGC) performance, and guard band size may be selected to reduce inter-subband CLI.

Aspects of the disclosure relate to configuring CLI measurements and reporting for SBFD time resources. The network may configure a CLI measurement resource for a UE measurement (e.g., for a CLI received signal strength indicator (RSSI) measurement or a sounding reference signal (SRS) reference signal received power (RSRP) measurement) in an SBFD time resource (e.g., an SBFD symbol or slot). The network may indicate, for the CLI measurement resource, in which subbands to measure CLI. For example, the network may indicate to measure CLI in: the downlink subbands; the downlink subbands and guard bands; the uplink subband; the uplink subband and guard bands; or the downlink subbands, guard bands, and the uplink subbands. The network may also indicate the reporting quantities, for example, whether to report the CLI measurement information separately for each subband or to combine the CLI measurements based on communication direction. In some aspects, CLI measurements may be generated and reported in a subband manner, meaning that the CLI measurement resource is separated into sets of frequency resources. In some aspects, some of the sets may overlap with different subbands of the SBFD slot or symbol. Aspects of the disclosure relate to CLI measurement generation and reporting when a CLI subband overlaps with different SBFD subbands. For example, the CLI measurement for the CLI subband may be generated for the uplink subband only, may be generated for both the uplink subband and the guard band, or may be skipped.

Aspects of the disclosure are initially described in the context of wireless communications systems. Aspects of the disclosure are further illustrated by and described with reference to resource diagrams, process flows, apparatus diagrams, system diagrams, and flowcharts that relate to CLI measurement in SBFD operation.

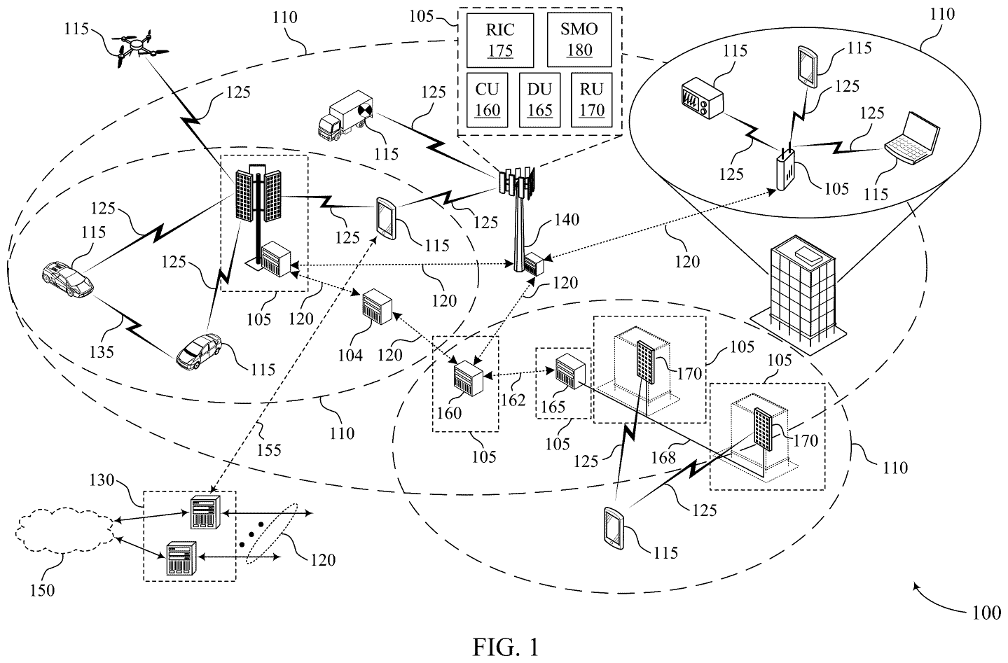

FIG. 1 shows an example of a wireless communications system 100 that supports CLI measurement in SBFD operation in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an IAB network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU 160, a DU 165, a RU 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a RRU, or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IaB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support CLI measurement in SBFD operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, In some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, In some aspects, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may implement full-duplex communication according to which network devices (e.g., network entities 105 and/or UEs 115) may simultaneously transmit and receive. In some deployments, a full-duplex capable network entity 105 may employ SBFD according to which the network entity 105 may receive via a first set of one or more subbands (which may be referred to as uplink subbands) and transmit via a second set of one or more subbands (which may be referred to as downlink subbands), where the first and second sets of subbands may be non-overlapping in the frequency domain. The uplink subbands and the downlink subbands may be separated by guard bands. Some UEs 115 may similarly be capable of full duplex communication and may employ SBFD. Some half-duplex UEs 115 may be SBFD aware, meaning that the network indicates the uplink and downlink subbands to the UE 115, though the UE 115 can either transmit or receive in a same time resource. In SBFD resources, a first UE 115 may experience CLI from a second UE 115 if the second UE 115 transmits using a frequency that is similar to a frequency of the uplink subbands or the downlink subbands, or both, used by the first UE 115. In some SBFD deployments (such as those in which the first UE 115 and the second UE 115 may use a same uplink subband), CLI in the uplink subband and the guard bands may affect communication performance, as intra-subband CLI may impact a receiver dynamic range and/or a receiver AGC performance, and guard band size may be selected to reduce inter-subband CLI.

The network may configure a CLI measurement resource for a UE 115 (e.g., for CLI received RSSI or SRS RSRP) measurement in an SBFD time resource. The network may indicate, for the CLI measurement resource, in which bands to measure CLI. For example, the network may indicate to measure CLI in: the downlink subbands; the downlink subbands and guard bands; the uplink subband; the uplink subband and guard bands; or the downlink subbands, guard bands, and the uplink subbands. The network may also indicate the reporting quantities, for example, whether to report the CLI measurement information separately for each subband or to combine the CLI measurements based on communication direction. In some aspects, CLI measurements may be generated and reported in a subband manner, meaning that the CLI measurement resource is separated into sets of frequency resources. In some aspects, some of the sets may overlap with different subbands of the SBFD slot or symbol. When a CLI subband overlaps with different SBFD subbands, for example, the CLI measurement for the CLI subband may be generated for the uplink subband only, may be generated for both the uplink subband and the guard band, or may be skipped.

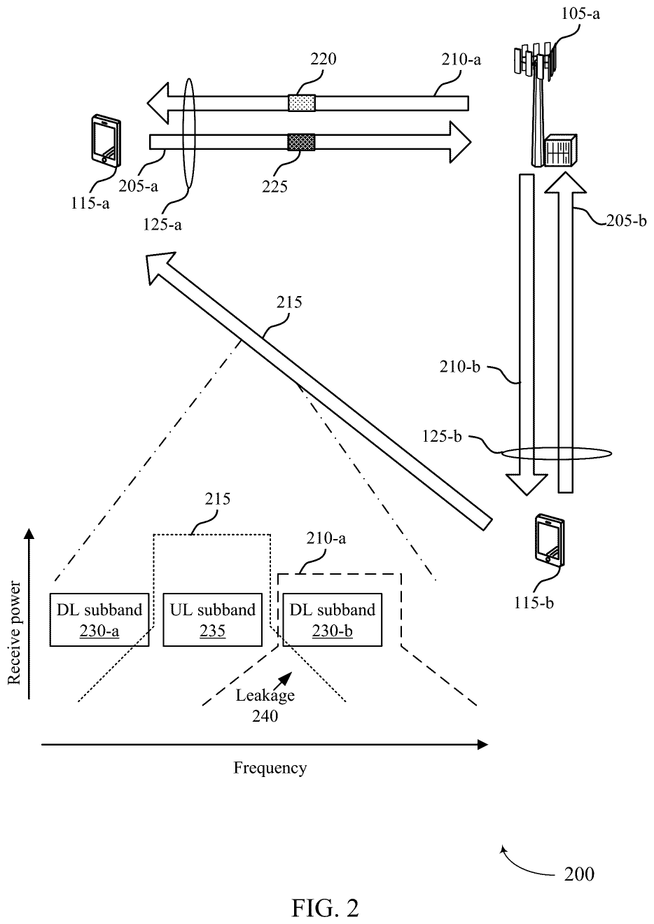

FIG. 2 shows an example of a wireless communications system 200 that supports CLI measurement in SBFD operation in accordance with one or more aspects of the present disclosure. The wireless communications system 200 may implement or may be implemented by aspects of the wireless communications system 100. For example, the wireless communications system 200 may include a UE 115-a and a UE 115-b, which may be examples of UEs 115 as described herein. The wireless communications system 200 may include a network entity 105-a, which may be an example of a network entity 105 as described herein.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-a. The communication link 125-a and the communication link 125-b may include bi-directional links that enable both uplink and downlink communications. For example, the UE 115-a may transmit uplink signals 205-a (e.g., uplink transmissions), such as uplink control signals or uplink data signals, to the network entity 105-a using the communication link 125-a and the network entity 105-a may transmit downlink signals 210-a (e.g., downlink transmissions), such as downlink control signals or downlink data signals, to the UE 115-a using the communication link 125-a. The UE 115-b may transmit uplink signals 205-b (e.g., uplink transmissions), such as uplink control signals or uplink data signals, to the network entity 105-a using the communication link 125-b and the network entity 105-a may transmit downlink signals 210-b (e.g., downlink transmissions), such as downlink control signals or downlink data signals, to the UE 115-a using the communication link 125-b.

The wireless communications system 200 may employ SBFD. In an SBFD time resource (e.g., an SBFD slot or symbol), the network entity 105-a may transmit a downlink signal 210-a to the UE 115-a via one or more downlink subbands 230 and may receive an uplink signal 205-a from the UE 115-a via one or more uplink subbands 235. Similarly, in an SBFD time resource (e.g., an SBFD slot or symbol), the network entity 105-a may transmit a downlink signal 210-b to the UE 115-b via one or more downlink subbands 230 and may receive an uplink signal 205-b from the UE 115-b via one or more uplink subbands 235. In some examples, an SBFD time resource may include a single DL subband 230 and a single UL subband 235, which may be separated by a guard band. However, the concepts discussed in relation to a structure including other quantities or configurations of subbands (e.g., two DL subbands and a single UL subband with one or more guard bands) are equally applicable to operations involving a single DL subband and a single UL subband. In an SBFD time resource, the UE 115-a may experience CLI 215 from the UE 115-b if the UE 115-b transmits an uplink signal 205-b using a frequency that is similar to a frequency of the uplink subbands 235 or the downlink subbands 230, or both, used by the UE 115-a. CLI 215 may negatively affect communication performance.

The UE 115-a may measure CLI 215 and report CLI 215 in a CLI report 225. In some aspects, the network may indicate a CLI measurement resource for the UE 115-a in control information 220, and the UE 115-a may use the indicated CLI measurement resource to measure the CLI 215. CLI measurements may be either RSSI-based CLI measurements or RSRP based CLI measurements. In a first CLI measurement method, the victim UE (the UE 115-a) may measure the CLI RSSI in a downlink subband 230 for any signal transmitted by the aggressor UE (the UE 115-b). In some aspects, the UE 115-a may separately measure and/or report CLI RSSI measurements for each downlink subband 230 (e.g., the downlink subband 230-a and the downlink subband 230-b). In some aspects, the UE 115-a may perform a CLI RSSI measurement and report the CLI RSSI for a single downlink subband downlink subband 230 (e.g., one of the downlink subband 230-a or the downlink subband 230-b). In some aspects, the CLI RSSI measurement and reporting may be based on a non-contiguous CLI RSSI resources across downlink subbands. In a second CLI measurement method, the victim UE (the UE 115-a) may measure the SRS-RSRP in the uplink subband 235 for an SRS transmitted by the aggressor UE (the UE 115-b) (e.g., similar to a CLI measurement when the uplink subband is confined within the active downlink BWP for the UE 115-a as in Third Generation Partnership Project (3GPP) Release 16). In a third CLI measurement method, the victim UE (the UE 115-a) may measure the CLI RSSI in the uplink subband 235 for any signal transmitted by the aggressor UE (the UE 115-b) (e.g., similar to a CLI measurement when the uplink subband is confined within the active downlink BWP for the UE 115-a as in 3GPP Release 16). A restriction as in 3GPP Release 16 that the UE 115-a measures the CLI only within the downlink BWP may not prohibit the UE 115-a from measuring the CLI in the uplink subband when the uplink subband is confined within the active downlink BWP for the UE 115-a.

As described herein, CLI 215 may negatively affect communication performance. For example, CLI 215 in a downlink subband 230 may affect reception of a downlink signal 210-a. Wideband CLI in a downlink subband may be affected (and may be dominated by) CLI 215 in the uplink band 235. For example, as shown, the energy of interference due to direct or same resource block (RB) CLI 215 in the uplink subband 235 may be much higher than CLI leakage 240 in the downlink subband 230-b. Thus, CLI 215 in the uplink subband 235 may impact a receiver dynamic range and/or a receiver AGC performance. Additionally, CLI 215 in the uplink subband and guard bands may affect the guard band size selection for guard bands between the uplink subbands 235 and the downlink subbands 230.

In some aspects, the control information 220 may indicate, a CLI measurement resource for the UE 115-a in an SBFD symbol or slot (e.g., an SBFD time resource). The control information 220 may also indicate for the CLI measurement resource, in which subbands to measure CLI 215 (e.g., which set of frequency resources within the CLI measurement resource to measure the CLI 215). For example, the network entity 105-a may indicate in the control information 220 to measure CLI 215 in: the downlink subbands 230; the downlink subbands 230 and guard bands; the uplink subband 235; the uplink subband 235 and guard bands; or the 230 downlink subbands, guard bands, and the uplink subbands 235. The network entity 105-a may also indicate in the control information 220 the reporting quantities for the CLI report 225, for example, whether to report the CLI measurement information separately for each subband or to combine the CLI measurements based on communication direction. In some aspects, the control information 220 may indicate for CLI measurements to be generated and reported in a subband manner, meaning that the CLI measurement resource is separated into sets of frequency resources. In some aspects, some of the sets may overlap with different subbands of the SBFD slot or symbol. When a CLI subband overlaps with different SBFD subbands, for example, the UE 115-a may generate the CLI measurement for the CLI subband for the uplink subband only, may generate the CLI measurement for both the uplink subband and the guard band, or the UE 115-a may skip the CLI measurement for the CLI subband. The UE 115-a may report the CLI measurement information generated for the CLI measurement resource in a CLI report 225 in accordance with the control information 220.

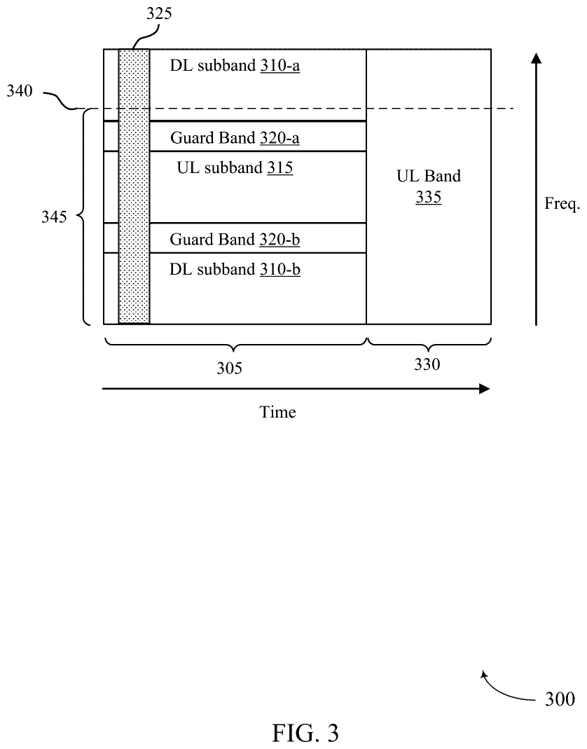

FIG. 3 shows an example of a resource diagram 300 that supports CLI measurement in SBFD operation in accordance with one or more aspects of the present disclosure. The resource diagram 300 may implement or may be implemented by aspects of wireless communications system 100 or the wireless communications system 200.

In some aspects, control information (e.g., the control information 220 of FIG. 2) may schedule a CLI measurement resource 325 in an SBFD time resource 305, and the CLI measurement resource 325 spans the downlink frequency resources (e.g., a downlink subband 310-a and a downlink subband 310-b), the uplink frequency resources (e.g., the uplink subband 315), and the guard band frequency resources (e.g., the guard band 320-a between the downlink subband 310-a and the uplink subband 315 and the guard band 320-b between the uplink subband 315 and the downlink subband 310-b). In some examples, the SBFD time resource 305 may include a single DL subband (e.g. the DL subband 310-a or the DL subband 310-b) and a single UL subband (e.g., the UL subband 315) separated by a single guard band (e.g., the Guard Band 320-a or the Guard Band 320-b). However, the concepts discussed in relation to a structure including other quantities or configurations of subbands (e.g., two DL subbands and a single UL subband with one or more guard bands) are equally applicable to operations involving a single DL subband and a single UL subband.

In some examples, the CLI measurement resource 325 may not span the downlink frequency resources and may instead only span frequency resources that are within a DL BWP corresponding to a UE. For example, the CLI measurement resource 325 may be coterminous with the boundary 340. In such a case, the CLI measurement resource may occupy the region 345 of the downlink resources and may not occupy the remainder of the DL subband 310.

As shown, SBFD time resources may alternate or may be interspersed with other types of time resources (e.g., uplink time resources 330 in which the uplink band 335 spans the active BWP for the UE 115 or downlink time resources in which the downlink band spans the active BWP for the UE 115). In aspects where the CLI measurement resource 325 spans the downlink, uplink, and guard band frequency resources of an SBFD time resource 305, the UE 115 may be configured by the control information to measure CLI using the CLI measurement resource 325 and report a wideband CLI RSSI. A wideband CLI RSSI may refer to a CLI RSSI measurement across multiple subbands or guard bands.

In some aspects, where the UE 115 may be configured by control information to measure CLI using the CLI measurement resource 325 and report a wideband CLI RSSI, the control information may indicate for the UE 115-a to measure CLI only within the frequency resources within the downlink subbands 310. In such aspects, the control information may indicate to either report a single RSSI quantity averaged across the downlink subbands 310 (e.g., the downlink subband 310-a and the downlink subband 310-b) or to report an RSSI measurements per downlink subband 310 (e.g., one RSSI measurement for the downlink subband 310-a and one RSSI measurement for the downlink subband 310-b). In such aspects, the UE 115 may exclude CLI measurements outside the downlink subbands 310 (e.g., including the guard bands 320). In such aspects, whether the wideband measurement is across both subbands or is per subband may be based on an RRC configuration, or may be indicated in the control message that schedules the CLI measurement resource or the CLI report.

In some aspects, where the UE 115 may be configured by control information to measure CLI using the CLI measurement resource 325 and report a wideband CLI RSSI, the control information may indicate for the UE 115-a to measure CLI within the frequency resources of the downlink subbands 310 and the guard bands 320. In such aspects, the control information may indicate to either report a single RSSI quantity averaged across the downlink subbands 310 and the guard bands (e.g., the downlink subband 310-a, the guard band 320-a, the guard band 320-b, and the downlink subband 310-b) or to report an RSSI measurements per downlink subband and adjacent guard band(s) combination (e.g., one RSSI measurement for the downlink subband 310-a and the guard band 320-a and one RSSI measurement for the downlink subband 310-b and the guard band 320-b). In such aspects, the UE 115 may exclude CLI measurements in the uplink subband 315. In such aspects, whether the wideband measurement is across both subbands or is per subband may be based on an RRC configuration, or may be indicated in the control message that schedules the CLI measurement resource or the CLI report. Whether to report a single CLI measurement or CLI measurements per downlink subband-guard band combination may be based on UE 115 implementation or an RRC configuration.

In some aspects, where the UE 115 may be configured by control information to measure CLI using the CLI measurement resource 325 and report a wideband CLI RSSI, the control information may indicate for the UE 115-a to measure CLI within all the frequency resources of the CLI measurement resource 325 except for the guard bands 320 (e.g., to measure the CLI in the downlink subband 310-a, the uplink subband 315, and the downlink subband 310-b) and to report the CLI per subband. For example, the UE 115 may be configured to report the CLI RSSI in the uplink subband 315 (e.g., for the blocking use case), the CLI RSSI in the downlink subband 310-a (e.g., for reporting leakage in the downlink subband 310-a), and the CLI RSSI in the downlink subband 310-b (e.g., for reporting leakage in the downlink subband 310-b).

In some aspects, where the UE 115 may be configured by control information to measure CLI using the CLI measurement resource 325 and report a wideband CLI RSSI, the control information may indicate for the UE 115-a to measure CLI within all the frequency resources of the CLI measurement resource 325 except for the guard bands 320 (e.g., to measure the CLI in the downlink subband 310-a, the uplink subband 315, and the downlink subband 310-b) and to report the CLI per direction. For example, the UE 115 may be configured to report the CLI RSSI in the uplink subband 315 (e.g., for the blocking use case), and a CLI RSSI averaged across the downlink subband 310-a and the downlink subband 310-b.

In some aspects, where the UE 115 may be configured by control information to measure CLI using the CLI measurement resource 325 and report a wideband CLI RSSI, the control information may indicate for the UE 115-a to measure CLI within all the frequency resources of the CLI measurement resource 325 and to report the CLI per direction and for the guard bands. For example, the UE 115 may be configured to report the CLI RSSI in the uplink subband 315 (e.g., for the blocking use case), a CLI RSSI averaged across the downlink subband 310-a and the downlink subband 310-b, and a CLI RSSI averaged across the guard band 320-a and the guard band 320-b.

In some aspects, where the UE 115 may be configured by control information to measure CLI using the CLI measurement resource 325 and report a wideband CLI RSSI, the control information may indicate for the UE 115-a to measure CLI within all the frequency resources of the CLI measurement resource 325 and to report the CLI per subband and guard band. For example, the UE 115 may be configured to report the CLI RSSI in the uplink subband 315, the CLI RSSI in the downlink subband 310-a, the CLI RSSI in the downlink subband 310-b, the CLI RSSI in the guard band 320-a, and the CLI RSSI in the guard band 320-b. In some aspects, the CLI RSSI in the downlink subbands 310 may be reported as a single CLI RSSI across the downlink subbands 310. In some aspects, the CLI RSSI in the downlink subbands 310 may be reported per downlink subband (e.g., one CLI RSSI for the downlink subband 310-a and one CLI RSSI for the downlink subband 310-b).

In some aspects, the control information that indicates the CLI measurement configuration may indicate an index to a preconfigured table to indicate which subbands to measure and the reporting quantities to report in a CLI report. For example, a table may be standardized or predetermined, and an RRC parameter may indicate an index of the table to indicate which subbands to measure and the reporting quantities to report in the CLI report. In some aspects, an RRC parameter as part of a CLI measurement report configuration may indicate which subbands to measure and the reporting quantities to report in a CLI report.

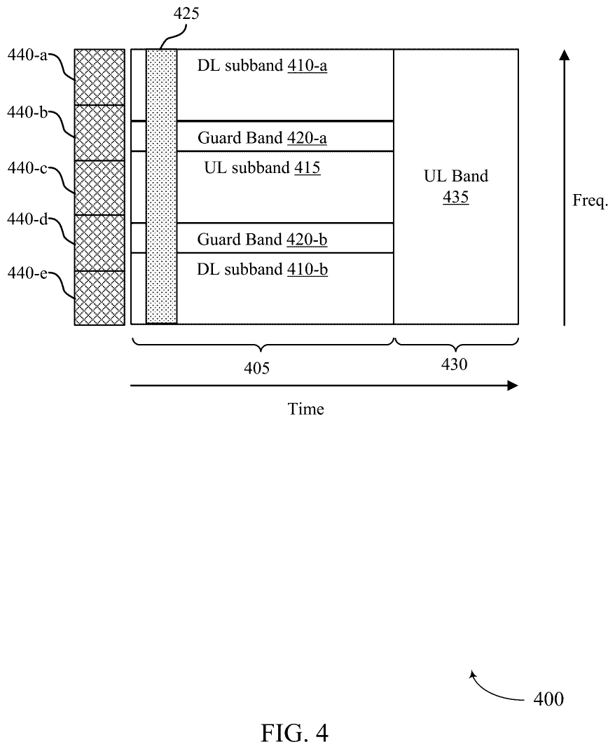

FIG. 4 shows an example of a resource diagram 400 that supports CLI measurement in SBFD operation in accordance with one or more aspects of the present disclosure. The resource diagram 400 may implement or may be implemented by aspects of wireless communications system 100 or the wireless communications system 200.

In some aspects, control information (e.g., the control information 220 of FIG. 2) may schedule a CLI measurement resource 425 in an SBFD time resource 405, and the CLI measurement resource 425 spans the downlink frequency resources (e.g., a downlink subband 410-a and a downlink subband), the uplink frequency resources (e.g., the uplink subband 415), and the guard band frequency resources (e.g., the guard band 420-a between the downlink subband 410-a and the uplink subband 415 and the guard band 420-b between the uplink subband 415 and the downlink subband 410-b). In some examples, the SBFD time resource 405 may include a single DL subband (e.g. the DL subband 410-a or the DL subband 410-b) and a single UL subband (e.g., the UL subband 415) separated by a single guard band (e.g., the Guard Band 420-a or the Guard Band 420-b). However, the concepts discussed in relation to a structure including other quantities or configurations of subbands (e.g., two DL subbands and a single UL subband with one or more guard bands) are equally applicable to operations involving a single DL subband and a single UL subband.

As shown, SBFD time resources may alternate or may be interspersed with other types of time resources (e.g., uplink time resources 430 in which the uplink band 435 spans the active BWP for the UE 115 or downlink time resources in which the downlink band spans the active BWP for the UE 115). In aspects where the CLI measurement resource 425 spans downlink, uplink, and guard band frequency resources of an SBFD time resource 405, the UE 115 may be configured by the control information to measure CLI using the CLI measurement resource 425 and to report subband CLI RSSI. For example, the UE 115 may be configured by the control information to measure and report the CLI per CLI subband 440 (e.g., a first CLI RSSI for the CLI subband 440-a, a second CLI RSSI for the CLI subband 440-b, a third CLI RSSI for the CLI subband 440-c, a fourth CLI RSSI for the CLI subband 440-d, and a fifth CLI RSSI for the CLI subband 440-c).

One or more of the CLI subbands 440 may overlap with the SBFD subband boundaries. For example, as shown, the CLI subband 440-b overlaps with the downlink subband 410-a, the guard band 420-a, and the uplink subband 415, and the CLI subband 440-d overlaps with the downlink subband 410-b, the guard band 420-b, and the uplink subband 415. In some aspects, for a CLI subband 440 that overlaps with SBFD subband boundaries, the UE 115 may measure the CLI RSSI for the CLI subband 440 only within the downlink frequency resources (e.g., the portion of the CLI subband 440-b within the downlink subband 410-a and the portion of the CLI subband 440-d within the downlink subband 410-b). In some aspects, for a CLI subband 440 that overlaps with SBFD subband boundaries, the UE 115 may measure the CLI RSSI for the CLI subband 440 only within the downlink frequency resources and the guard band frequency resources (e.g., the portion of the CLI subband 440-b within the downlink subband 410-a and the guard band 420-a and the portion of the CLI subband 440-d within the downlink subband 410-b and the guard band 420-b). In some aspects, for a CLI subband 440 that overlaps with SBFD subband boundaries, the UE 115 may ignore that CLI subband 440 (e.g., the UE 115 may not measure or report CLI RSSI for the CLI subband 440-b or the CLI subband 440-d).

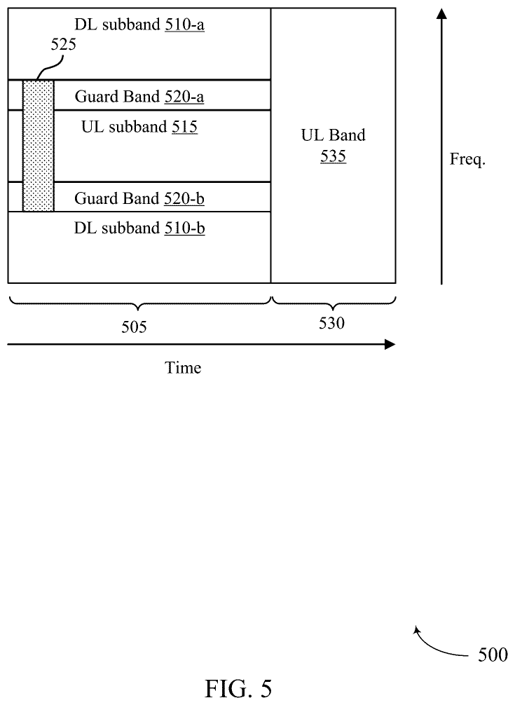

FIG. 5 shows an example of a resource diagram 500 that supports CLI measurement in SBFD operation in accordance with one or more aspects of the present disclosure. The resource diagram 500 may implement or may be implemented by aspects of wireless communications system 100 or the wireless communications system 200.

In some aspects, control information (e.g., the control information 220 of FIG. 2) may schedule a CLI measurement resource 525 in an SBFD time resource 505, and the CLI measurement resource 525 spans the uplink frequency resources (e.g., the uplink subband 515) and at least a portion of the guard band frequency resources (e.g., the guard band 520-a between the downlink subband 510-a and the uplink subband 515 and the guard band 520-b between the uplink subband 515 and the downlink subband 510-b). In some examples, the SBFD time resource 505 may include a single DL subband (e.g. the DL subband 510-a or the DL subband 510-b) and a single UL subband (e.g., the UL subband 515) separated by a single guard band (e.g., the Guard Band 520-a or the Guard Band 520-b). However, the concepts discussed in relation to a structure including other quantities or configurations of subbands (e.g., two DL subbands and a single UL subband with one or more guard bands) are equally applicable to operations involving a single DL subband and a single UL subband.

As shown, SBFD time resources may alternate or may be interspersed with other types of time resources (e.g., uplink time resources 530 in which the uplink band 535 spans the active BWP for the UE 115 or downlink time resources in which the downlink band spans the active BWP for the UE 115).

In some aspects where the CLI measurement resource 525 spans the uplink subband 515 and at least a portion of the guard band frequency resources of an SBFD time resource 505, the UE 115 may be configured by the control information to measure CLI using the CLI measurement resource and report a wideband CLI RSRP. A wideband CLI RSRP refers to a single CLI RSRP value being reported for the uplink subband 515. In some aspects where the UE 115 is configured to report a wideband CLI RSRP, the UE 115 may measure and report the CLI RSRP only within the uplink subband 515 (e.g., as the aggressor UE 115 transmits the SRS within the uplink subband 515). In some aspects where the UE 115 is configured to report a wideband CLI RSRP, the UE 115 may measure and report the CLI RSRP within the uplink subband 515 and the guard bands 520 (e.g., the guard band 520-a and the guard band 520-b), if the CLI measurement resource includes any frequency resources in the guard bands 520. For example, the UE 115 may measure and report the CLI RSRP within the uplink subband 515 and the guard bands 520 if the aggressor UE 115 is allowed to or configured to transmit an SRS in the guard band(s) 520. In some aspects where the UE 115 is configured to report a wideband CLI RSRP, the UE 115 may measure and report the CLI RSRP within the uplink subband 515 and some frequency resources of the guard bands 520 such that the measured frequency resources map to a valid SRS sequence.

In some aspects where the CLI measurement resource 525 spans the uplink subband 515 and guard band frequency resources of an SBFD time resource 505, the UE 115 may be configured by the control information to measure CLI using the CLI measurement resource and report a wideband CLI RSSI. A wideband CLI RSSI refers to a single CLI RSSI value being reported for the uplink subband 515. In some aspects where the UE 115 is configured to report a wideband CLI RSSI, the UE 115 may measure and report the CLI RSRP only within the uplink subband 515. In some aspects where the UE 115 is configured to report a wideband CLI RSSI, the UE 115 may measure and report the CLI RSRP within the uplink subband 515 and the guard bands 520 (e.g., if the CLI measurement resource 525 includes any frequency resources in the guard bands 520.

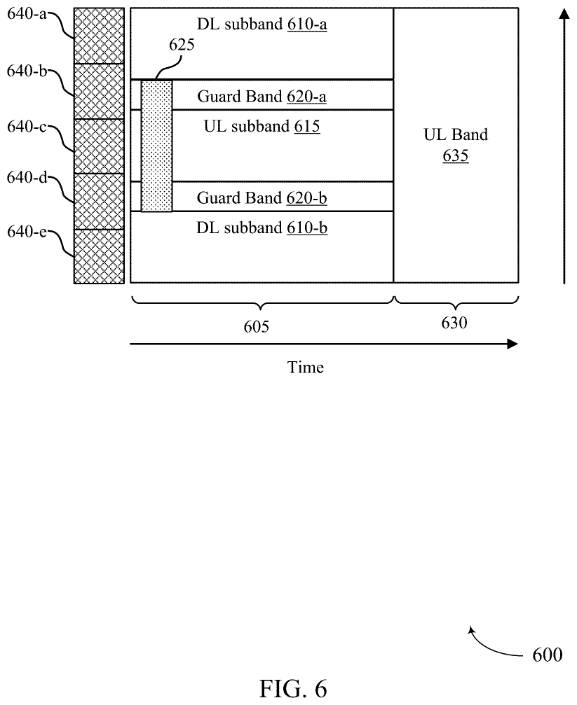

FIG. 6 shows an example of a resource diagram 600 that supports CLI measurement in SBFD operation in accordance with one or more aspects of the present disclosure. The resource diagram 600 may implement or may be implemented by aspects of wireless communications system 100 or the wireless communications system 200.

In some aspects, control information (e.g., the control information 220 of FIG. 2) may schedule a CLI measurement resource 625 in an SBFD time resource 605, and the CLI measurement resource 625 spans the uplink frequency resources (e.g., the uplink subband 615) and at least a portion of the guard band frequency resources (e.g., the guard band 620-a between the downlink subband 610-a and the uplink subband 615 and the guard band 620-b between the uplink subband 615 and the downlink subband 610-b). In some examples, the SBFD time resource 605 may include a single DL subband (e.g, the DL subband 610-a or the DL subband 610-b) and a single UL subband (e.g., the UL subband 615) separated by a single guard band (e.g., the Guard Band 620-a or the Guard Band 620-b). However, the concepts discussed in relation to a structure including other quantities or configurations of subbands (e.g., two DL subbands and a single UL subband with one or more guard bands) are equally applicable to operations involving a single subband and a single UL subband.

As shown, SBFD time resources may alternate or may be interspersed with other types of time resources (e.g., uplink time resources 630 in which the uplink band 635 spans the active BWP for the UE 115 or downlink time resources in which the downlink band spans the active BWP for the UE 115). In aspects where the CLI measurement resource 625 spans the uplink subband 615 and at least a portion of the guard band frequency resources of an SBFD time resource 605, the UE 115 may be configured by the control information to measure CLI using the CLI measurement resource and report subband CLI RSSI or subband CLI RSRP. For example, the UE 115 may be configured by the control information to measure and report the CLI per CLI subband 640 (e.g., a first CLI RSSI or CLI RSRP for the CLI subband 640-a, a second CLI RSSI or CLI RSRP for the CLI subband 640-b, a third CLI RSSI or CLI RSRP for the CLI subband 640-c, a fourth CLI RSSI or CLI RSRP for the CLI subband 640-d, and a fifth CLI RSSI or CLI RSRP for the CLI subband 640-c).

One or more of the CLI subbands 640 may overlap with the SBFD subband boundaries. For example, as shown, the CLI subband 640-b overlaps with the downlink subband 610-a, the guard band 620-a, and the uplink subband 615, and the CLI subband 640-d overlaps with the downlink subband 610-b, the guard band 620-b, and the uplink subband 615. As the CLI subband 640-a and the CLI subband 640-e are outside of the CLI measurement resource 625, the UE 115 may not measure or report CLI RSSI or CLI RSRP for the CLI subband 640-a and the CLI subband 640-c.

In some aspects, for a CLI subband that overlaps with the subband boundaries, the UE 115 may measure CLI RSRP only within the uplink subband 615 (e.g., the portion of the CLI subband 640-b within the uplink subband 615 and the portion of the CLI subband 640-d within the uplink subband 615), which may be referred to as partial subband-CLI in the uplink subband. In such aspects, the CLI report may be derived based on SRS resources excluding SRS resources outside the uplink subband 615. In some aspects, for a CLI subband that overlaps with the subband boundaries, the UE 115 may measure CLI RSRP within the uplink subband 615 and the guard band frequency resources (e.g., the portion of the CLI subband 640-b within the uplink subband 615 and the guard band 620-a and the portion of the CLI subband 640-d within the uplink subband 615 and the guard band 620-b), which may be referred to as partial subband-CLI in the uplink subband plus the guard band. In such aspects, the CLI report may be derived based on SRS resources excluding SRS resources in the downlink subbands 610. In some aspects, for a CLI subband 640 that overlaps with SBFD subband boundaries, the UE 115 may ignore that CLI subband 640 (e.g., the UE 115 may not measure or report CLI RSRP for the CLI subband 640-b or the CLI subband 640-d).

In some aspects, for a CLI subband that overlaps with the subband boundaries, the UE 115 may measure CLI RSSI only within the uplink subband 615 (e.g., the portion of the CLI subband 640-b within the uplink subband 615 and the portion of the CLI subband 640-d within the uplink subband 615), which may be referred to as partial subband-CLI RSSI in the uplink subband. In some aspects, for a CLI subband that overlaps with the subband boundaries, the UE 115 may measure CLI RSSI within the uplink subband 615 and the guard band frequency resources (e.g., the portion of the CLI subband 640-b within the uplink subband 615 and the guard band 620-a and the portion of the CLI subband 640-d within the uplink subband 615 and the guard band 620-b), which may be referred to as partial subband-CLI RSSI in the uplink subband plus the guard band. In some aspects, for a CLI subband 640 that overlaps with SBFD subband boundaries, the UE 115 may ignore that CLI subband 640 (e.g., the UE 115 may not measure or report CLI RSSI for the CLI subband 640-b or the CLI subband 640-d).

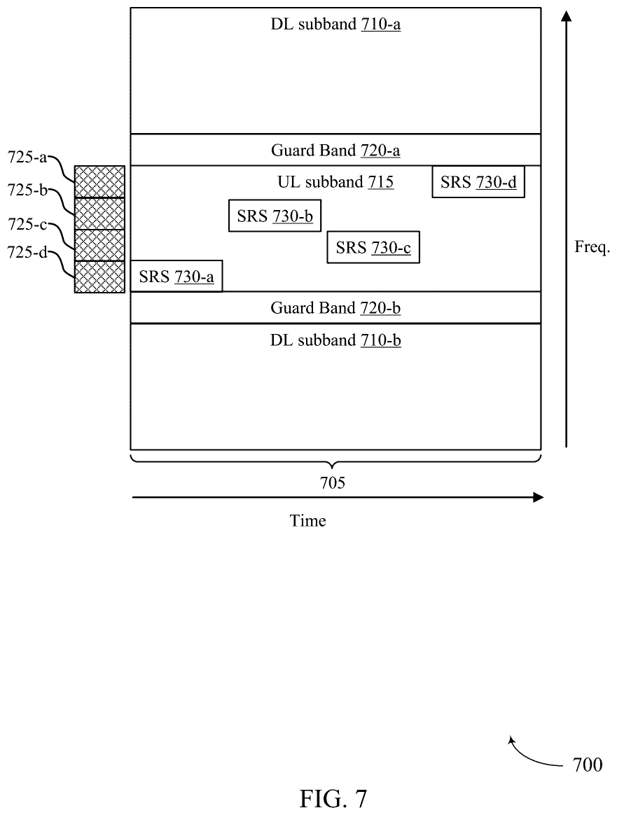

FIG. 7 shows an example of a resource diagram 700 that supports CLI measurement in SBFD operation in accordance with one or more aspects of the present disclosure. The resource diagram 700 may implement or may be implemented by aspects of wireless communications system 100 or the wireless communications system 200.

In some aspects, a frequency hopping pattern may be configured for transmissions of SRSs 730 by an aggressor UE 115 within an SBFD time resource 705. The SBFD time resource 705 includes a downlink subband 710-a, a downlink subband 710-b, an uplink subband 715, a guard band 720-a between the downlink subband 710-a and the uplink subband 715, and a guard band 720-b between the downlink subband 710-b and the uplink subband 715. In some examples, the SBFD time resource 705 may include a single DL subband (e.g. the DL subband 710-a or the DL subband 710-b) and a single UL subband (e.g., the UL subband 715) separated by a single guard band (e.g., the Guard Band 720-a or the Guard Band 720-b). However, the concepts discussed in relation to a structure including other quantities or configurations of subbands (e.g., two DL subbands a single UL subband with one or more guard bands) are equally applicable to operations involving a single DL subband and a single UL subband.

For example, a first SRS 730-a may be transmitted in a first subset of frequency resources of the uplink subband 715, a second SRS 730-b may be transmitted in a second subset of frequency resources of the uplink subband 715, a third SRS 730-c may be transmitted in a third subset of frequency resources of the uplink subband 715, and a fourth SRS 730-d may be transmitted in a fourth subset of frequency resources of the uplink subband 715. The victim UE 115 may be configured (e.g., via the control information 220 of FIG. 2) to measure CLI based on the SRSs 730 (e.g., the victim UE may be configured to measure CLI-SRS-RSRP). Accordingly, the victim UE 115 may be configured with a first CLI measurement resource 725-a corresponding to the first SRS 730-a, a second CLI measurement resource 725-b corresponding to the second SRS 730-b, a third CLI measurement resource 725-c corresponding to the third SRS 730-c, and a fourth CLI measurement resource 725-d corresponding to the fourth SRS 730-d. In some aspects, the victim UE 115 may be configured transmit a CLI report for each CLI measurement resource 725 after reception and measurement of the CLI for each SRS 730. In some aspects, the victim UE 115 may be configured transmit a CLI report that includes the CLI measurement for each CLI measurement resource 725 after reception of all of the SRSs 730.

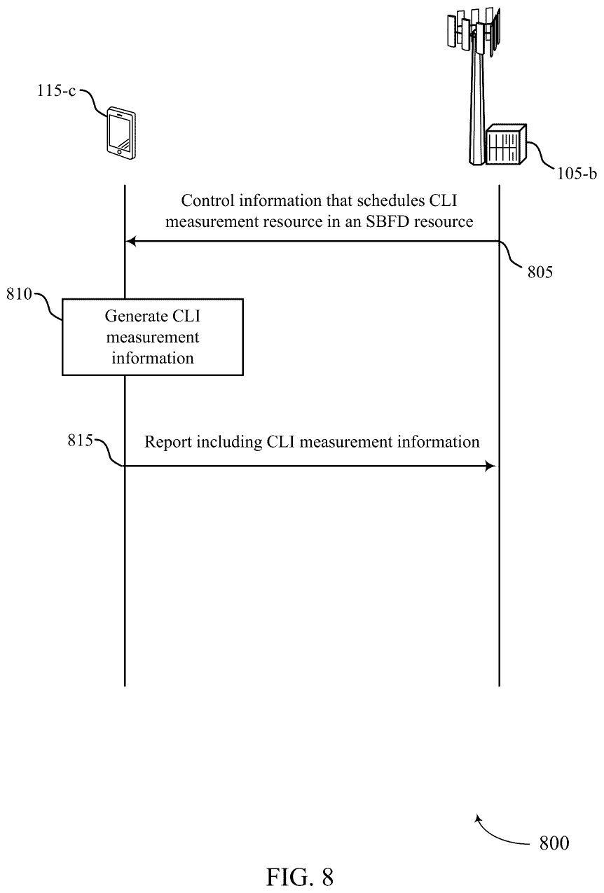

FIG. 8 shows an example of a process flow 800 that supports CLI measurement in SBFD operation in accordance with one or more aspects of the present disclosure. The process flow 800 may implement or be implemented by aspects of wireless communications system 100 or the wireless communications system 200. For example, the process flow 800 may include a UE 115-c, which may be an example of a UE 115 as described herein. The process flow 800 may also include a network entity 105-b, which may be an example of a network entity 105 as described herein. In the following description of the process flow 800, the operations between the network entity 105-b and the UE 115-c may be transmitted in a different order than the example order shown, or the operations performed by the network entity 105-b and the UE 115-c may be performed in different orders or at different times. Some operations may also be omitted from the process flow 800, and other operations may be added to the process flow 800.

At 805, the UE 115-c may receive, from the network entity 105-b, control information (e.g., one or more control messages such as RRC or a MAC control element (MAC-CE)) that schedules a CLI measurement resource that spans at least a portion of a set of multiple frequency resources of an SBFD time resource. The set of multiple frequency resources includes a first guard band that separates a first downlink subband in frequency from an uplink subband a second guard band that separates a second downlink subband in frequency from the uplink subband. The control information is indicative of a set of frequency resources of the set of multiple frequency resources for measurement within the CLI measurement resource, and the control information is indicative of a CLI report configuration. The CLI report configuration is indicative of one or more types of information to be included in a CLI report that is in accordance with the CLI report configuration.

At 810, the UE 115-c may generate, using a portion of the set of frequency resources that overlaps with a downlink bandwidth part for the first network entity, CLI measurement information.

At 815, the UE 115-c may transmit, to the network entity 105-b, a first report indicative of the CLI measurement information generated at 805, where the first report is in accordance with the CLI report configuration.

In some aspects, the CLI measurement resource spans the set of multiple frequency resources of the SBFD time resource, and the one or more types of information includes one or more CLI RSSI values.

In some aspects, the set of frequency resources is the first downlink subband and a second downlink subband included in the plurality of frequency resources and separated from the uplink resource by a second guard band, and the one or more types of information includes a single CLI RSSI value that is an average of the CLI measurement information generated for the first downlink subband and the second downlink subband that overlap with the downlink bandwidth part for the first network entity.

In some aspects, the set of frequency resources is the first downlink subband and a second downlink subband included in the plurality of frequency resources and separated from the uplink resource by a second guard band, and where the one or more types of information includes the CLI measurement information that overlaps with the DL BWP for the first network entity on a per-downlink subband basis.

In some aspects, the set of frequency resources is the first downlink subband, a second downlink subband included in the plurality of frequency resources and separated from the uplink resource by a second guard band, the first guard band, and the second guard band, and where the one or more types of information includes a single CLI RSSI value that is an average of the CLI measurement information generated for the first downlink subband, the second downlink subband, the first guard band, and the second guard band.

In some aspects, the set of frequency resources is the first downlink subband, a second downlink subband included in the plurality of frequency resources and separated from the uplink resource by a second guard band, the first guard band, and the second guard band, and the one or more types of information includes a first CLI RSSI value generated for the first downlink subband and the first guard band and a second CLI RSSI value generated for the second downlink subband and the second guard band.

In some aspects, the set of frequency resources is the first downlink subband, the second downlink subband, and the uplink subband, and the one or more types of information includes the CLI measurement information on a per-downlink subband or uplink subband basis.

In some aspects, the set of frequency resources is the first downlink subband, the second downlink subband, and the uplink subband, and the one or more types of information includes a first CLI RSSI value that is an average of the CLI measurement information generated for the first downlink subband and the second downlink subband and a second CLI RSSI value generated for the uplink subband.

In some aspects, the set of frequency resources is the first downlink subband, the second downlink subband, the uplink subband, the first guard band, and the second guard band, and the one or more types of information includes a first CLI RSSI value that is an average of the CLI measurement information generated for the first downlink subband and the second downlink subband, a second CLI RSSI value generated for the uplink subband, and a third CLI RSSI value that is an average of the CLI measurement information generated for the first guard band and the second guard band.

In some aspects, the set of frequency resources is the first downlink subband, the second downlink subband, the uplink subband, the first guard band, and the second guard band, and the one or more types of information includes the CLI measurement information on a per-downlink subband basis, a per-uplink subband basis, and a per guard band basis.

In some aspects, the control information may include an index (e.g., of a table) indicative of a combination of the set of frequency resources and the CLI report configuration.

In some aspects, the control information may be included in a cross link interference report configuration.

In some aspects, the CLI measurement resource spans the set of multiple frequency resources of the SBFD time resource, the CLI report configuration is for a reporting subband that at least partially overlaps with the first downlink subband, wherein the reporting subband is one or a plurality of CLI measurement subbands that overlap the plurality of frequency resources, and the one or more types of information includes a CLI RSSI value. In some aspects, generating the CLI measurement information includes measuring CLI within only a portion of the reporting subband that overlaps with the first downlink subband. In some aspects, generating the CLI measurement information includes measuring CLI within only a portion of the reporting subband that overlaps with the first downlink subband and the first guard band.

In some aspects, the CLI measurement resource spans the uplink subband and the first guard band, the CLI measurement information pertains to measurements of only the uplink subband, the one or more types of information includes a CLI RSRP value or an RSSI value, and the RSRP value or the RSSI value is associated with the measurements of only the uplink subband.

In some aspects, the CLI measurement resource spans the uplink subband and the first guard band, the CLI measurement information pertains to measurements of the uplink subband and the first guard band, the one or more types of information includes a CLI RSRP value or an RSSI value, and the RSRP value or the RSSI value is a wideband reporting that is associated with the measurements of the uplink subband and the first guard band.

In some aspects, the CLI measurement resource spans the uplink subband and the first guard band, the CLI measurement information pertains to measurements of the uplink subband and at least a first portion of the first guard band and a second portion of the second guard band, the uplink subband and at least the first portion of the first guard band are associated with a SRS sequence, and the one or more types of information includes a CLI RSRP value or an RSSI value, and the RSRP value or the RSSI value is associated with the measurements of the uplink subband and at least the first portion of the first guard band.

In some aspects, the CLI measurement resource spans the uplink subband and at least the first guard band, the one or more types of information includes a CLI RSRP value or an RSSI value, and the RSRP value or the RSSI value is associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

In some aspects, the CLI measurement resource spans the uplink subband and at least the first guard band, the one or more types of information includes a CLI RSRP value or an RSSI value, and the RSRP value or the RSSI value is associated with measurements of only a portion of a reporting subband that overlaps with the uplink subband and at least the first guard band.

In some aspects, the CLI measurement resource corresponds to a set of multiple SRS hopping occasions within the uplink subband, the one or more types of information includes one or more CLI RSRP values, and each of the one or more RSRP values is associated with measurements of a respective reporting subband that overlaps with a corresponding one of the set of multiple SRS hopping occasions. In some aspects, the one or more types of information includes a single RSRP value or RSSI value for a most recent one of the set of multiple SRS hopping occasions. In some aspects, the

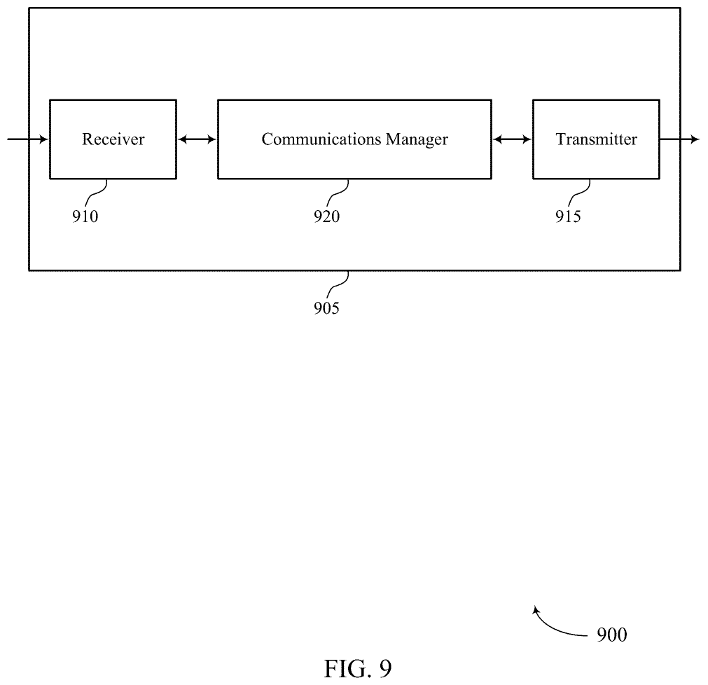

FIG. 9 shows a block diagram 900 of a device 905 that supports CLI measurement in SBFD operation in accordance with one or more aspects of the present disclosure. The device 05 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to CLI measurement in SBFD operation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to CLI measurement in SBFD operation). In some aspects, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of CLI measurement in SBFD operation as described herein. For example, the communications manager 920, the receiver 910, the transmitter 915, or various combinations or components thereof may support a method for performing one or more of the functions described herein.

In some aspects, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, In some aspects, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first network entity in accordance with examples as disclosed herein. For example, the communications manager 920 is capable of, configured to, or operable to support a means for receiving, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The communications manager 920 is capable of, configured to, or operable to support a means for generating, using a portion of the set of frequency resources that overlaps with a downlink bandwidth part for the first network entity, CLI measurement information. The communications manager 920 is capable of, configured to, or operable to support a means for transmitting, to the second network entity, a first report indicative of the CLI measurement information, where the first report is in accordance with the CLI report configuration.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

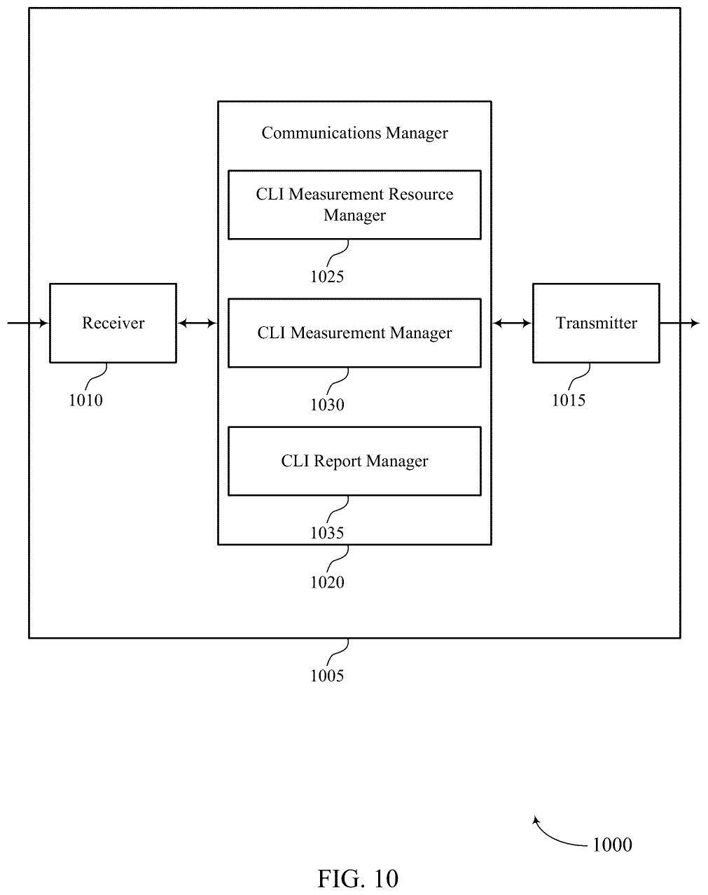

FIG. 10 shows a block diagram 1000 of a device 1005 that supports CLI measurement in SBFD operation in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to CLI measurement in SBFD operation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to CLI measurement in SBFD operation). In some aspects, the transmitter 1015 may be co-located with a receiver 1010 in a transceiver module. The transmitter 1015 may utilize a single antenna or a set of multiple antennas.

The device 1005, or various components thereof, may be an example of means for performing various aspects of CLI measurement in SBFD operation as described herein. For example, the communications manager 1020 may include a CLI measurement resource manager 1025, a CLI measurement manager 1030, a CLI report manager 1035, or any combination thereof. The communications manager 1020 may be an example of aspects of a communications manager 920 as described herein. In some aspects, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first network entity in accordance with examples as disclosed herein. The CLI measurement resource manager 1025 is capable of, configured to, or operable to support a means for receiving, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The CLI measurement manager 1030 is capable of, configured to, or operable to support a means for generating, using a portion of the set of frequency resources that overlaps with a downlink bandwidth part for the first network entity, CLI measurement information. The CLI report manager 1035 is capable of, configured to, or operable to support a means for transmitting, to the second network entity, a first report indicative of the CLI measurement information, where the first report is in accordance with the CLI report configuration.

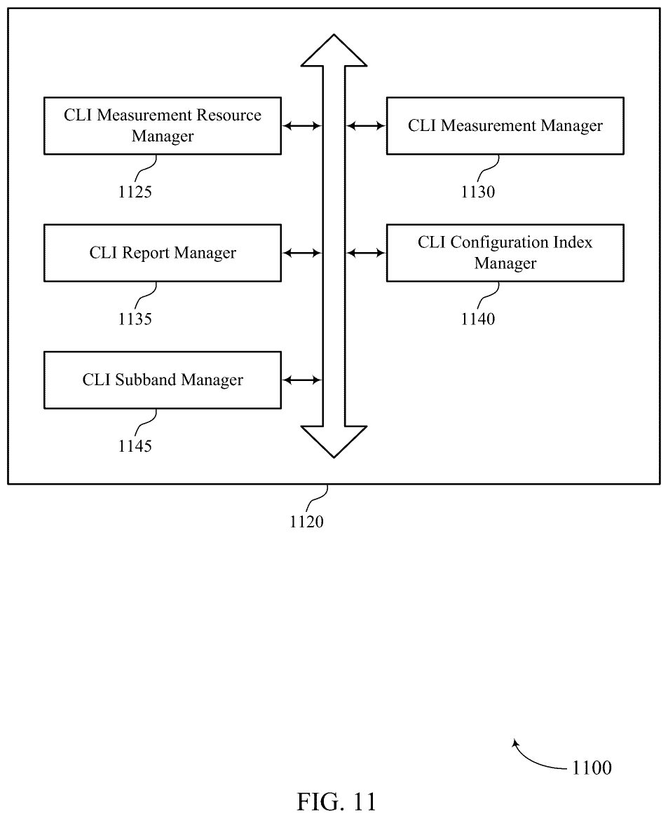

FIG. 11 shows a block diagram 1100 of a communications manager 1120 that supports CLI measurement in SBFD operation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of CLI measurement in SBFD operation as described herein. For example, the communications manager 1120 may include a CLI measurement resource manager 1125, a CLI measurement manager 1130, a CLI report manager 1135, a CLI configuration index manager 1140, a CLI subband manager 1145, or any combination thereof. Each of these components may communicate, directly or indirectly, with one another (e.g., via one or more buses).

The communications manager 1120 may support wireless communications at a first network entity in accordance with examples as disclosed herein. The CLI measurement resource manager 1125 is capable of, configured to, or operable to support a means for receiving, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The CLI measurement manager 1130 is capable of, configured to, or operable to support a means for generating, using a portion of the set of frequency resources that overlaps with a downlink bandwidth part for the first network entity, CLI measurement information. The CLI report manager 1135 is capable of, configured to, or operable to support a means for transmitting, to the second network entity, a first report indicative of the CLI measurement information, where the first report is in accordance with the CLI report configuration.

In some aspects, the CLI measurement resource spans the set of multiple frequency resources of the SBFD time resource. In some aspects, the one or more types of information includes one or more CLI RSSI values.

In some aspects, the set of frequency resources is the first downlink subband and a second downlink subband included in the plurality of frequency resources and separated from the uplink resource by a second guard band. In some aspects, the one or more types of information includes a single CLI RSSI value that is an average of the CLI measurement information generated for the first downlink subband and the second downlink subband that overlap with the downlink bandwidth part for the first network entity.

In some aspects, the set of frequency resources is the first downlink subband and a second downlink subband included in the plurality of frequency resources and separated from the uplink resource by a second guard band. In some aspects, the one or more types of information includes the CLI measurement information that overlaps with the DL BWP for the first network entity on a per-downlink subband basis.

In some aspects, the set of frequency resources is the first downlink subband, a second downlink subband included in the plurality of frequency resources and separated from the uplink resource by a second guard band, the first guard band, and the second guard band. In some aspects, the one or more types of information includes a single CLI RSSI value that is an average of the CLI measurement information generated for the first downlink subband, the second downlink subband, the first guard band, and the second guard band.

In some aspects, the set of frequency resources is the first downlink subband, a second downlink subband included in the plurality of frequency resources and separated from the uplink resource by a second guard band, the first guard band, and the second guard band. In some aspects, the one or more types of information includes a first CLI RSSI value generated for the first downlink subband and the first guard band and a second CLI RSSI value generated for the second downlink subband and the second guard band.

In some aspects, the set of frequency resources is the first downlink subband, the second downlink subband, and the uplink subband. In some aspects, the one or more types of information includes the CLI measurement information on a per-downlink subband or uplink subband basis.

In some aspects, the set of frequency resources is the first downlink subband, the second downlink subband, and the uplink subband. In some aspects, the one or more types of information includes a first CLI RSSI value that is an average of the CLI measurement information generated for the first downlink subband and the second downlink subband and a second CLI RSSI value generated for the uplink subband.

In some aspects, the set of frequency resources is the first downlink subband, the second downlink subband, the uplink subband, the first guard band, and the second guard band. In some aspects, the one or more types of information includes a first CLI RSSI value that is an average of the CLI measurement information generated for the first downlink subband and the second downlink subband, a second CLI RSSI value generated for the uplink subband, and a third CLI RSSI value that is an average of the CLI measurement information generated for the first guard band and the second guard band.

In some aspects, the set of frequency resources is the first downlink subband, the second downlink subband, the uplink subband, the first guard band, and the second guard band. In some aspects, the one or more types of information includes the CLI measurement information on a per-downlink subband basis, a per-uplink subband basis, and a per guard band basis.

In some aspects, to support receiving the control information, the CLI configuration index manager 1140 is capable of, configured to, or operable to support a means for receiving an index indicative of a combination of the set of frequency resources and the CLI report configuration.

In some aspects, to support receiving the control information, the CLI configuration index manager 1140 is capable of, configured to, or operable to support a means for receiving a cross link interference report configuration, where the control information is included in the cross link interference report configuration.

In some aspects, the CLI measurement resource spans the set of multiple frequency resources of the SBFD time resource. In some aspects, the CLI report configuration is for a reporting subband that at least partially overlaps with one of the first downlink subband or the second downlink subband. In some aspects, the one or more types of information includes a CLI RSSI value.

In some aspects, to support generating the CLI measurement information, the CLI subband manager 1145 is capable of, configured to, or operable to support a means for measuring CLI within only a portion of the reporting subband that overlaps with the first downlink subband.

In some aspects, to support generating the CLI measurement information, the CLI subband manager 1145 is capable of, configured to, or operable to support a means for measuring CLI within only a portion of the reporting subband that overlaps with the first downlink subband and the first guard band.

In some aspects, the CLI measurement resource spans the uplink subband and the first guard band. In some aspects, the CLI measurement information pertains to measurements of only the uplink subband. In some aspects, the one or more types of information includes a CLI RSRP value or an RSSI value. In some aspects, the RSRP value or the RSSI value is associated with the measurements of only the uplink subband.

In some aspects, the CLI measurement resource spans the uplink subband and the first guard band. In some aspects, the CLI measurement information pertains to measurements of the uplink subband and the first guard band. In some aspects, the one or more types of information includes a CLI RSRP value or an RSSI value. In some aspects, the RSRP value or the RSSI value is a wideband reporting that is associated with the measurements of the uplink subband and the first guard band.

In some aspects, the CLI measurement resource spans the uplink subband and the first guard band. In some aspects, the CLI measurement information pertains to measurements of the uplink subband and at least a first portion of the first guard band and a second portion of the second guard band. In some aspects, the uplink subband and at least the first portion of the first guard band are associated with a SRS sequence, and the one or more types of information includes a CLI RSRP value or an RSSI value. In some aspects, the RSRP value or the RSSI value is associated with the measurements of the uplink subband and at least the first portion of the first guard band.

In some aspects, the CLI measurement resource spans the uplink subband and at least the first guard band. In some aspects, the one or more types of information includes a CLI RSRP value or an RSSI value. In some aspects, the RSRP value or the RSSI value is associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

In some aspects, the CLI measurement resource spans the uplink subband and at least the first guard band. In some aspects, the one or more types of information includes a CLI RSRP value or an RSSI value. In some aspects, the RSRP value or the RSSI value is associated with measurements of only a portion of a reporting subband that overlaps with the uplink subband and at least the first guard band.

In some aspects, the CLI measurement resource corresponds to a set of multiple SRS hopping occasions within the uplink subband. In some aspects, the one or more types of information includes one or more CLI RSRP values or one or more RSSI values. In some aspects, each of the one or more RSRP values is associated with measurements of a respective reporting subband that overlaps with a corresponding one of the set of multiple SRS hopping occasions.

In some aspects, the one or more types of information includes a single RSRP value or RSSI value for a most recent one of the set of multiple SRS hopping occasions.

In some aspects, the one or more types of information includes a set of multiple RSRP values or RSSI values, each of the set of multiple RSRP values or RSSI values associated with a respective one of the set of multiple SRS hopping occasions.

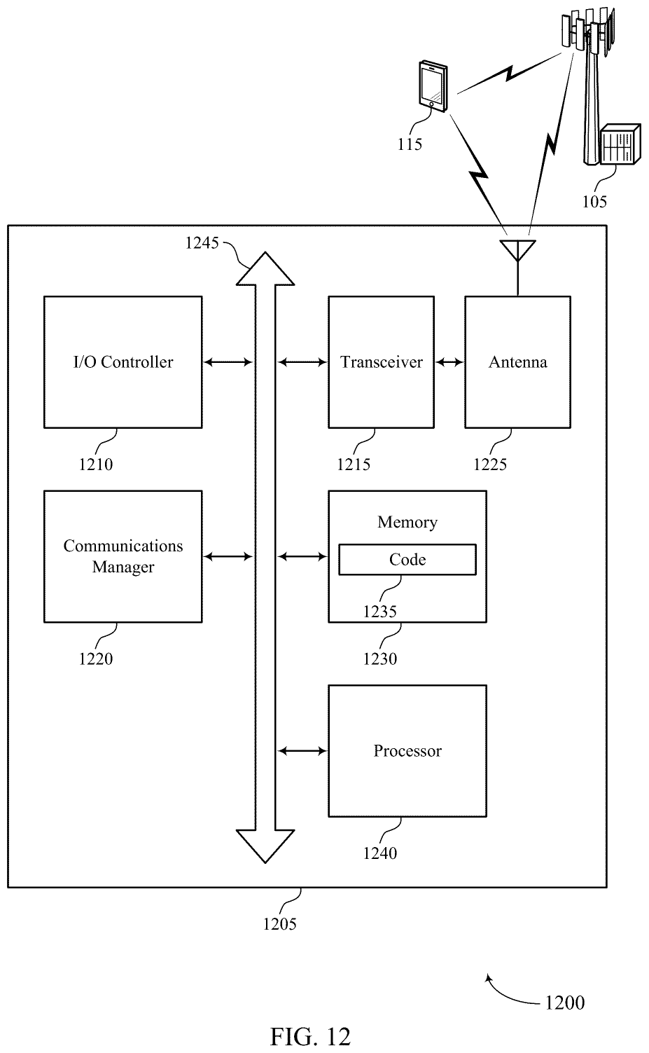

FIG. 12 shows a diagram of a system 1200 including a device 1205 that supports CLI measurement in SBFD operation in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting CLI measurement in SBFD operation). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a first network entity in accordance with examples as disclosed herein. For example, the communications manager 1220 is capable of, configured to, or operable to support a means for receiving, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The communications manager 1220 is capable of, configured to, or operable to support a means for generating, using a portion of the set of frequency resources that overlaps with a downlink bandwidth part for the first network entity, CLI measurement information. The communications manager 1220 is capable of, configured to, or operable to support a means for transmitting, to the second network entity, a first report indicative of the CLI measurement information, where the first report is in accordance with the CLI report configuration.

By including or configuring the communications manager 1220 in accordance with examples as described herein, the device 1205 may support techniques for more efficient utilization of communication resources, improved coordination between devices and improved utilization of processing capability.

In some aspects, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, In some aspects, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of CLI measurement in SBFD operation as described herein, or the processor 1240 and the memory 1230 may be otherwise configured to perform or support such operations.

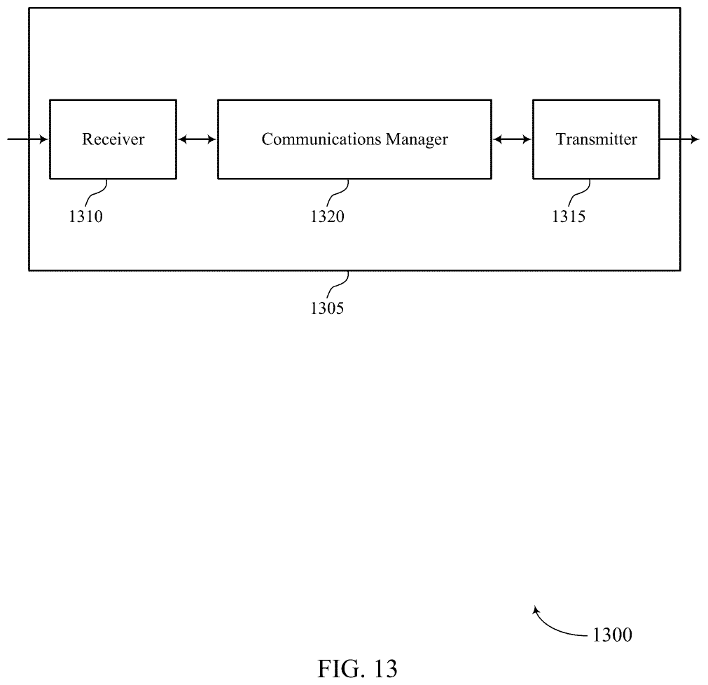

FIG. 13 shows a block diagram 1300 of a device 1305 that supports CLI measurement in SBFD operation in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some aspects, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some aspects, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of CLI measurement in SBFD operation as described herein. For example, the communications manager 1320, the receiver 1310, the transmitter 1315, or various combinations or components thereof may support a method for performing one or more of the functions described herein.

In some aspects, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, In some aspects, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a first network entity in accordance with examples as disclosed herein. For example, the communications manager 1320 is capable of, configured to, or operable to support a means for transmitting, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The communications manager 1320 is capable of, configured to, or operable to support a means for receiving, from the second network entity, a first report indicative of CLI measurement information associated with the set of frequency resources in accordance with the CLI report configuration.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for more efficient utilization of communication resources.

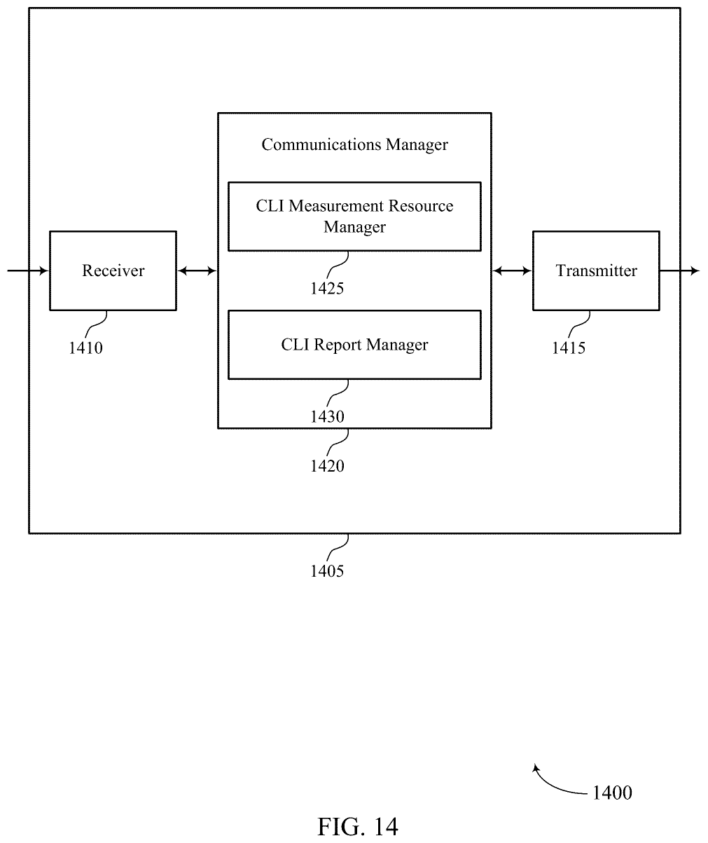

FIG. 14 shows a block diagram 1400 of a device 1405 that supports CLI measurement in SBFD operation in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some aspects, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some aspects, the transmitter 1415 and the receiver 1410 may be co-located in a transceiver, which may include or be coupled with a modem.

The device 1405, or various components thereof, may be an example of means for performing various aspects of CLI measurement in SBFD operation as described herein. For example, the communications manager 1420 may include a CLI measurement resource manager 1425 a CLI report manager 1430, or any combination thereof. The communications manager 1420 may be an example of aspects of a communications manager 1320 as described herein. In some aspects, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a first network entity in accordance with examples as disclosed herein. The CLI measurement resource manager 1425 is capable of, configured to, or operable to support a means for transmitting, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The CLI report manager 1430 is capable of, configured to, or operable to support a means for receiving, from the second network entity, a first report indicative of CLI measurement information associated with the set of frequency resources in accordance with the CLI report configuration.

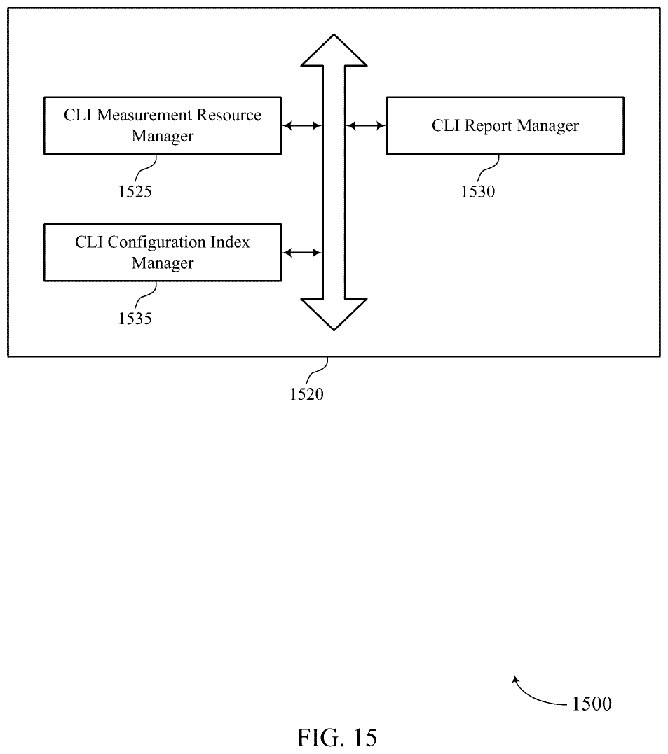

FIG. 15 shows a block diagram 1500 of a communications manager 1520 that supports CLI measurement in SBFD operation in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of CLI measurement in SBFD operation as described herein. For example, the communications manager 1520 may include a CLI measurement resource manager 1525, a CLI report manager 1530, a CLI configuration index manager 1535, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a first network entity in accordance with examples as disclosed herein. The CLI measurement resource manager 1525 is capable of, configured to, or operable to support a means for transmitting, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The CLI report manager 1530 is capable of, configured to, or operable to support a means for receiving, from the second network entity, a first report indicative of CLI measurement information associated with the set of frequency resources in accordance with the CLI report configuration.

In some aspects, the CLI measurement resource spans the set of multiple frequency resources of the SBFD time resource. In some aspects, the one or more types of information includes one or more CLI RSSI values.

In some aspects, the set of frequency resources is the first downlink subband and a second downlink subband included in the plurality of frequency resources and separated from the uplink resource by a second guard band. In some aspects, the one or more types of information includes a single CLI RSSI value that is an average of the CLI measurement information generated for the first downlink subband and the second downlink subband that overlap with the downlink bandwidth part for the first network entity.

In some aspects, the set of frequency resources is the first downlink subband and a second downlink subband included in the plurality of frequency resources and separated from the uplink resource by a second guard band. In some aspects, the one or more types of information includes the CLI measurement information that overlaps with the DL BWP for the first network entity on a per-downlink subband basis.

In some aspects, the set of frequency resources is the first downlink subband, a second downlink subband included in the plurality of frequency resources and separated from the uplink resource by a second guard band, the first guard band, and the second guard band. In some aspects, the one or more types of information includes a single CLI RSSI value that is an average of the CLI measurement information generated for the first downlink subband, the second downlink subband, the first guard band, and the second guard band.

In some aspects, the set of frequency resources is the first downlink subband, a second downlink subband included in the plurality of frequency resources and separated from the uplink resource by a second guard band, the first guard band, and the second guard band. In some aspects, the one or more types of information includes a first CLI RSSI value generated for the first downlink subband and the first guard band and a second CLI RSSI value generated for the second downlink subband and the second guard band.

In some aspects, the set of frequency resources is the first downlink subband, the second downlink subband, and the uplink subband. In some aspects, the one or more types of information includes the CLI measurement information on a per-downlink subband or uplink subband basis.

In some aspects, the set of frequency resources is the first downlink subband, the second downlink subband, and the uplink subband. In some aspects, the one or more types of information includes a first CLI RSSI value that is an average of the CLI measurement information generated for the first downlink subband and the second downlink subband and a second CLI RSSI value generated for the uplink subband.

In some aspects, the set of frequency resources is the first downlink subband, the second downlink subband, the uplink subband, the first guard band, and the second guard band. In some aspects, the one or more types of information includes a first CLI RSSI value that is an average of the CLI measurement information generated for the first downlink subband and the second downlink subband, a second CLI RSSI value generated for the uplink subband, and a third CLI RSSI value that is an average of the CLI measurement information generated for the first guard band and the second guard band.

In some aspects, the set of frequency resources is the first downlink subband, the second downlink subband, the uplink subband, the first guard band, and the second guard band. In some aspects, the one or more types of information includes the CLI measurement information on a per-downlink subband basis, a per-uplink subband basis, and a per guard band basis.

In some aspects, to support transmitting the control information, the CLI configuration index manager 1535 is capable of, configured to, or operable to support a means for transmitting an index indicative of a combination of the set of frequency resources and the CLI report configuration.

In some aspects, to support transmitting the control information, the CLI configuration index manager 1535 is capable of, configured to, or operable to support a means for transmitting a cross link interference report configuration, wherein the control information is included in the cross link interference report configuration.

In some aspects, the CLI measurement resource spans the set of multiple frequency resources of the SBFD time resource. In some aspects, the CLI report configuration is for a reporting subband that at least partially overlaps with one of the first downlink subband or the second downlink subband. In some aspects, the one or more types of information includes a CLI RSSI value.

In some aspects, the CLI report configuration indicates that only a portion of the reporting subband that overlaps with the one of the first downlink subband or the second downlink subband is to be included in the CLI report that is in accordance with the CLI report configuration.

In some aspects, the CLI report configuration indicates that only a portion of the reporting subband that overlaps with the one of the first downlink subband or the second downlink subband and any of the first guard band or the second guard band is to be included in the CLI report that is in accordance with the CLI report configuration.

In some aspects, the CLI measurement resource spans the uplink subband and the first guard band. In some aspects, the CLI measurement information pertains to measurements of only the uplink subband. In some aspects, the one or more types of information includes a CLI RSRP value or an RSSI value. In some aspects, the RSRP value or the RSSI value is associated with the measurements of only the uplink subband.

In some aspects, the CLI measurement resource spans the uplink subband and the first guard band. In some aspects, the CLI measurement information pertains to measurements of the uplink subband and the first guard band. In some aspects, the one or more types of information includes a CLI RSRP value or an RSSI value. In some aspects, the RSRP value or the RSSI value is a wideband reporting that is associated with the measurements of the uplink subband and the first guard band.

In some aspects, the CLI measurement resource spans the uplink subband and the first guard band. In some aspects, the CLI measurement information pertains to measurements of the uplink subband and at least a first portion of the first guard band and a second portion of the second guard band. In some aspects, the uplink subband and at least the first portion of the first guard band are associated with a SRS sequence. In some aspects, the one or more types of information includes a CLI RSRP value or an RSSI value. In some aspects, the RSRP value or the RSSI value is associated with the measurements of the uplink subband and at least the first portion of the first guard band.

In some aspects, the CLI measurement resource spans the uplink subband and at least the first guard band. In some aspects, the one or more types of information includes a CLI RSRP value or an RSSI value. In some aspects, the RSRP value or the RSSI value is associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

In some aspects, the CLI measurement resource spans the uplink subband and at least the first guard band. In some aspects, the one or more types of information includes a CLI RSRP value or an RSSI value. In some aspects, the RSRP value or the RSSI value is associated with measurements of only a portion of a reporting subband that overlaps with the uplink subband and at least the first guard band.

In some aspects, the CLI measurement resource corresponds to a set of multiple SRS hopping occasions within the uplink subband. In some aspects, the one or more types of information includes one or more CLI RSRP values or one or more RSSI values. In some aspects, each of the one or more RSRP values is associated with measurements of a respective reporting subband that overlaps with a corresponding one of the set of multiple SRS hopping occasions.

In some aspects, the one or more types of information includes a single RSRP value or RSSI value for a most recent one of the set of multiple SRS hopping occasions.

In some aspects, the one or more types of information includes a set of multiple RSRP values or RSSI values, each of the set of multiple RSRP values or RSSI values associated with a respective one of the set of multiple SRS hopping occasions.

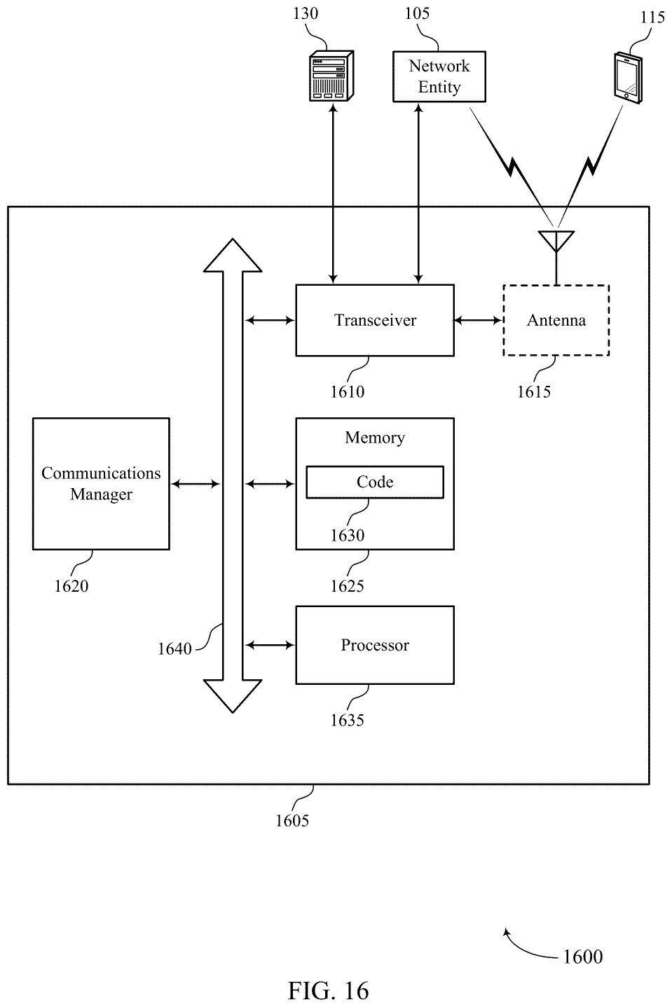

FIG. 16 shows a diagram of a system 1600 including a device 1605 that supports CLI measurement in SBFD operation in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some aspects, the transceiver 1610 may include a wired transceiver and may communicate bi-directionally with another wired transceiver. Additionally, or alternatively, In some aspects, the transceiver 1610 may include a wireless transceiver and may communicate bi-directionally with another wireless transceiver. In some aspects, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some aspects, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting CLI measurement in SBFD operation). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1640 may support communications of (e.g., within) a protocol layer of a protocol stack. In some aspects, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some aspects, the communications manager 1620 may manage aspects of communications with a core network 130 (e.g., via one or more wired or wireless backhaul links). For example, the communications manager 1620 may manage the transfer of data communications for client devices, such as one or more UEs 115. In some aspects, the communications manager 1620 may manage communications with other network entities 105, and may include a controller or scheduler for controlling communications with UEs 115 in cooperation with other network entities 105. In some aspects, the communications manager 1620 may support an X2 interface within an LTE/LTE-A wireless communications network technology to provide communication between network entities 105.

The communications manager 1620 may support wireless communications at a first network entity in accordance with examples as disclosed herein. For example, the communications manager 1620 is capable of, configured to, or operable to support a means for transmitting, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The communications manager 1620 is capable of, configured to, or operable to support a means for receiving, from the second network entity, a first report indicative of CLI measurement information associated with the set of frequency resources in accordance with the CLI report configuration.

By including or configuring the communications manager 1620 in accordance with examples as described herein, the device 1605 may support techniques for more efficient utilization of communication resources, improved coordination between devices and improved utilization of processing capability.

In some aspects, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, In some aspects, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of CLI measurement in SBFD operation as described herein, or the processor 1635 and the memory 1625 may be otherwise configured to perform or support such operations.

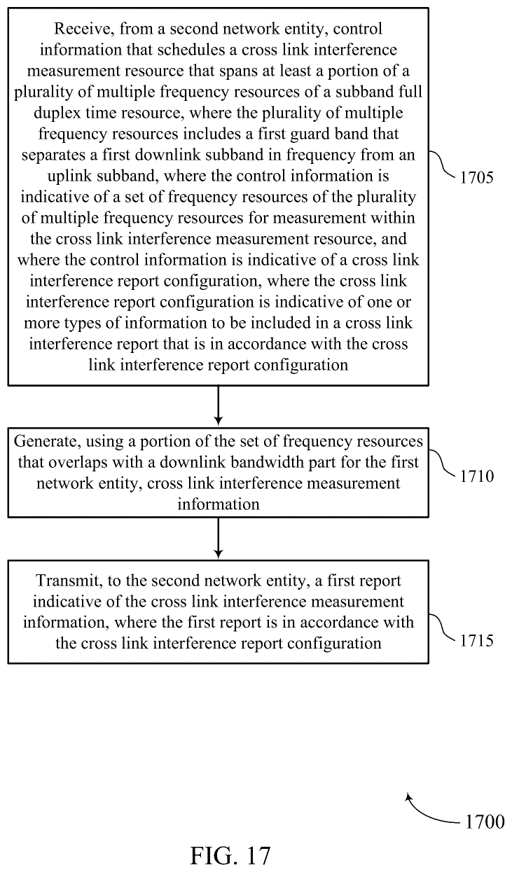

FIG. 17 shows a flowchart illustrating a method 1700 that supports CLI measurement in SBFD operation in accordance with aspects of the present disclosure. The operations of the method 1700 may be implemented by a UE or its components as described herein. For example, the operations of the method 1700 may be performed by a UE 115 as described with reference to FIGS. 1 through 12. In some aspects, a UE may execute a set of instructions to control the functional elements of the UE to perform the described functions. Additionally, or alternatively, the UE may perform aspects of the described functions using special-purpose hardware.

At 1705, the method may include receiving, from a second network entity, control information that schedules a CLI measurement resource that spans at least a portion of a set of multiple frequency resources of a SBFD time resource, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The operations of block 1705 may be performed in accordance with examples as disclosed herein. In some aspects, aspects of the operations of 1705 may be performed by a CLI measurement resource manager 1125 as described with reference to FIG. 11.

At 1710, the method may include generating, using a portion of the set of frequency resources that overlaps with a downlink bandwidth part for the first network entity, CLI measurement information. The operations of block 1710 may be performed in accordance with examples as disclosed herein. In some aspects, aspects of the operations of 1710 may be performed by a CLI measurement manager 1130 as described with reference to FIG. 11.

At 1715, the method may include transmitting, to the second network entity, a first report indicative of the CLI measurement information, where the first report is in accordance with the CLI report configuration. The operations of block 1715 may be performed in accordance with examples as disclosed herein. In some aspects, aspects of the operations of 1715 may be performed by a CLI report manager 1135 as described with reference to FIG. 11.

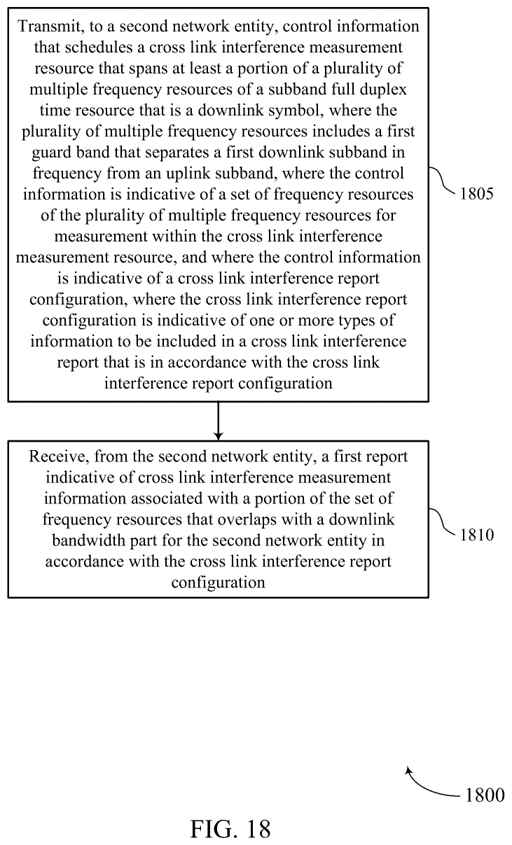

FIG. 18 shows a flowchart illustrating a method 1800 that supports CLI measurement in SBFD operation in accordance with aspects of the present disclosure. The operations of the method 1800 may be implemented by a network entity or its components as described herein. For example, the operations of the method 1800 may be performed by a network entity as described with reference to FIGS. 1 through 8 and 13 through 16. In some aspects, a network entity may execute a set of instructions to control the functional elements of the network entity to perform the described functions. Additionally, or alternatively, the network entity may perform aspects of the described functions using special-purpose hardware.

At 1805, the method may include transmitting, to a second network entity, control information that schedules a CLI measurement resource that spans at least a portion of a set of multiple frequency resources of a SBFD time resource that is a downlink symbol, where the set of multiple frequency resources includes a first guard band that separates a first downlink subband in frequency from an uplink subband, where the control information is indicative of a set of frequency resources of the set of multiple frequency resources for measurement within the CLI measurement resource, and where the control information is indicative of a CLI report configuration, where the CLI report configuration is indicative of one or more types of information to be included in a CLI report that is in accordance with the CLI report configuration. The operations of block 1805 may be performed in accordance with examples as disclosed herein. In some aspects, aspects of the operations of 1805 may be performed by a CLI measurement resource manager 1525 as described with reference to FIG. 15.

At 1810, the method may include receiving, from the second network entity, a first report indicative of CLI measurement information associated with the set of frequency resources in accordance with the CLI report configuration. The operations of block 1810 may be performed in accordance with examples as disclosed herein. In some aspects, aspects of the operations of 1810 may be performed by a CLI report manager 1530 as described with reference to FIG. 15.

The following provides an overview of aspects of the present disclosure:

Aspect 1: A method for wireless communication at a first network entity, comprising: receiving, from a second network entity, control information that schedules a CLI measurement resource that spans at least a portion of a plurality of frequency resources of a SBFD time resource, wherein the plurality of frequency resources includes a first guard band that separates a first downlink subband in frequency from an uplink subband, wherein the control information is indicative of a set of frequency resources of the plurality of frequency resources for measurement within the CLI measurement resource, and wherein the control information is indicative of a CLI report configuration, wherein the CLI report configuration is indicative of one or more types of information to be included in a CLI report that is in accordance with the CLI report configuration; generating, using a portion of the set of frequency resources that overlaps with a downlink bandwidth part for the first network entity, CLI measurement information; and transmitting, to the second network entity, a first report indicative of the CLI measurement information, wherein the first report is in accordance with the CLI report configuration.

Aspect 2: The method of aspect 1, wherein the CLI measurement resource spans the plurality of frequency resources of the SBFD time resource, and the one or more types of information includes one or more CLI RSSI values.

Aspect 3: The method of aspect 2, wherein the set of frequency resources is the first downlink subband and a second downlink subband included in the plurality of frequency resources and separated from the uplink resource by a second guard band, and the one or more types of information includes a single CLI RSSI value that is an average of the CLI measurement information generated for the first downlink subband and the second downlink subband that overlap with the downlink bandwidth part for the first network entity.

Aspect 4: The method of aspect 2, wherein the set of frequency resources is the first downlink subband and a second downlink subband included in the plurality of frequency resources and separated from the uplink resource by a second guard band, and the one or more types of information includes the CLI measurement information that overlaps with the DL BWP for the first network entity on a per-downlink subband basis.

Aspect 5: The method of aspect 2, wherein the set of frequency resources is the first downlink subband, a second downlink subband included in the plurality of frequency resources and separated from the uplink resource by a second guard band, the first guard band, and the second guard band, and the one or more types of information includes a single CLI RSSI value that is an average of the CLI measurement information generated for the first downlink subband, the second downlink subband, the first guard band, and the second guard band.

Aspect 6: The method of aspect 2, wherein the set of frequency resources is the first downlink subband, a second downlink subband included in the plurality of frequency resources and separated from the uplink resource by a second guard band, the first guard band, and the second guard band, and the one or more types of information includes a first CLI RSSI value generated for the first downlink subband and the first guard band and a second CLI RSSI value generated for the second downlink subband and the second guard band.

Aspect 7: The method of aspect 2, wherein the set of frequency resources is the first downlink subband, the second downlink subband, and the uplink subband, and the one or more types of information includes the CLI measurement information on a per-downlink subband or uplink subband basis.

Aspect 8: The method of aspect 2, wherein the set of frequency resources is the first downlink subband, the second downlink subband, and the uplink subband, and the one or more types of information includes a first CLI RSSI value that is an average of the CLI measurement information generated for the first downlink subband and the second downlink subband and a second CLI RSSI value generated for the uplink subband.

Aspect 9: The method of aspect 2, wherein the set of frequency resources is the first downlink subband, the second downlink subband, the uplink subband, the first guard band, and the second guard band, and the one or more types of information includes a first CLI RSSI value that is an average of the CLI measurement information generated for the first downlink subband and the second downlink subband, a second CLI RSSI value generated for the uplink subband, and a third CLI RSSI value that is an average of the CLI measurement information generated for the first guard band and the second guard band.

Aspect 10: The method of aspect 2, wherein the set of frequency resources is the first downlink subband, the second downlink subband, the uplink subband, the first guard band, and the second guard band, and the one or more types of information includes the CLI measurement information on a per-downlink subband basis, a per-uplink subband basis, and a per guard band basis.

Aspect 11: The method of any of aspects 2 through 10, wherein receiving the control information comprises: receiving an index indicative of a combination of the set of frequency resources and the CLI report configuration.

Aspect 12: The method of any of aspects 2 through 12, wherein receiving the control information comprises: receiving an index indicative of a combination of the set of frequency resources and the CLI report configuration.

Aspect 13: The method of aspect 1, wherein the CLI measurement resource spans the plurality of frequency resources of the SBFD time resource, the CLI report configuration is for a reporting subband that at least partially overlaps with the first downlink subband, wherein the reporting subband is one or a plurality of CLI measurement subbands that overlap the plurality of frequency resources, the one or more types of information includes a CLI RSSI value.

Aspect 14: The method of aspect 13, wherein generating the CLI measurement information comprises: measuring CLI within only a portion of the reporting subband that overlaps with the first downlink subband.

Aspect 15: The method of aspect 13, wherein generating the CLI measurement information comprises: measuring CLI within only a portion of the reporting subband that overlaps with the first downlink subband and the first guard band.

Aspect 16: The method of aspect 1, wherein the CLI measurement resource spans the uplink subband and the first guard band, the CLI measurement information pertains to measurements of only the uplink subband, the one or more types of information includes a CLI RSRP value or an RSSI value, the RSRP value or the RSSI value is associated with the measurements of only the uplink subband.

Aspect 17: The method of aspect 1, wherein the CLI measurement resource spans the uplink subband and the first guard band, the CLI measurement information pertains to measurements of the uplink subband and the first guard band, the one or more types of information includes a CLI RSRP value or an RSSI value, the RSRP value or the RSSI value is a wideband reporting that is associated with the measurements of the uplink subband and the first guard band.

Aspect 18: The method of aspect 1, wherein the CLI measurement resource spans the uplink subband and the first guard band, the CLI measurement information pertains to measurements of the uplink subband and at least a first portion of the first guard band and a second portion of the second guard band, the uplink subband and at least the first portion of the first guard band are associated with a sounding reference signal sequence, and the one or more types of information includes a CLI RSRP value or an RSSI value, the RSRP value or the RSSI value is associated with the measurements of the uplink subband and at least the first portion of the first guard band.

Aspect 19: The method of aspect 1, wherein the CLI measurement resource spans the uplink subband and at least the first guard band, the one or more types of information includes a CLI RSRP value or an RSSI value, the RSRP value or the RSSI value is associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

Aspect 20: The method of aspect 1, wherein the CLI measurement resource spans the uplink subband and at least the first guard band, the one or more types of information includes a CLI RSRP value or an RSSI value, the RSRP value or the RSSI value is associated with measurements of only a portion of a reporting subband that overlaps with the uplink subband and at least the first guard band.

Aspect 21: The method of aspect 1, wherein the CLI measurement resource corresponds to a plurality of SRS hopping occasions within the uplink subband, the one or more types of information includes one or more CLI RSRP values, each of the one or more RSRP values is associated with measurements of a respective reporting subband that overlaps with a corresponding one of the plurality of SRS hopping occasions.

Aspect 22: The method of aspect 21, wherein the one or more types of information includes a single RSRP value or RSSI value for a most recent one of the plurality of SRS hopping occasions.

Aspect 23: The method of aspect 21, wherein the one or more types of information includes a plurality of RSRP values or RSSI values, each of the plurality of RSRP values or RSSI values associated with a respective one of the plurality of SRS hopping occasions.

Aspect 24: A method for wireless communication at a first network entity, comprising: transmitting, to a second network entity, control information that schedules a CLI measurement resource that spans at least a portion of a plurality of frequency resources of a SBFD time resource that is a downlink symbol, wherein the plurality of frequency resources includes a first guard band that separates a first downlink subband in frequency from an uplink subband, wherein the control information is indicative of a set of frequency resources of the plurality of frequency resources for measurement within the CLI measurement resource, and wherein the control information is indicative of a CLI report configuration, wherein the CLI report configuration is indicative of one or more types of information to be included in a CLI report that is in accordance with the CLI report configuration; and receiving, from the second network entity, a first report indicative of CLI measurement information associated with the set of frequency resources in accordance with the CLI report configuration.

Aspect 25: The method of aspect 24, wherein the CLI measurement resource spans the plurality of frequency resources of the SBFD time resource, and the one or more types of information includes one or more CLI RSSI values.

Aspect 26: The method of aspect 25, wherein the set of frequency resources is the first downlink subband and a second downlink subband included in the plurality of frequency resources and separated from the uplink resource by a second guard band, and the one or more types of information includes a single CLI RSSI value that is an average of the CLI measurement information generated for the first downlink subband and the second downlink subband that overlap with the downlink bandwidth part for the first network entity.

Aspect 27: The method of aspect 25, wherein the set of frequency resources is the first downlink subband and a second downlink subband included in the plurality of frequency resources and separated from the uplink resource by a second guard band, and the one or more types of information includes the CLI measurement information that overlaps with the DL BWP for the first network entity on a per-downlink subband basis.

Aspect 28: The method of aspect 25, wherein the set of frequency resources is the first downlink subband, a second downlink subband included in the plurality of frequency resources and separated from the uplink resource by a second guard band, the first guard band, and the second guard band, and the one or more types of information includes a single CLI RSSI value that is an average of the CLI measurement information generated for the first downlink subband, the second downlink subband, the first guard band, and the second guard band.

Aspect 29: The method of aspect 25, wherein the set of frequency resources is the first downlink subband, a second downlink subband included in the plurality of frequency resources and separated from the uplink resource by a second guard band, the first guard band, and the second guard band, and the one or more types of information includes a first CLI RSSI value generated for the first downlink subband and the first guard band and a second CLI RSSI value generated for the second downlink subband and the second guard band.

Aspect 30: The method of aspect 25, wherein the set of frequency resources is the first downlink subband, the second downlink subband, and the uplink subband, and the one or more types of information includes the CLI measurement information on a per-downlink subband or uplink subband basis.

Aspect 31: The method of aspect 25, wherein the set of frequency resources is the first downlink subband, the second downlink subband, and the uplink subband, and the one or more types of information includes a first CLI RSSI value that is an average of the CLI measurement information generated for the first downlink subband and the second downlink subband and a second CLI RSSI value generated for the uplink subband.

Aspect 32: The method of aspect 25, wherein the set of frequency resources is the first downlink subband, the second downlink subband, the uplink subband, the first guard band, and the second guard band, and the one or more types of information includes a first CLI RSSI value that is an average of the CLI measurement information generated for the first downlink subband and the second downlink subband, a second CLI RSSI value generated for the uplink subband, and a third CLI RSSI value that is an average of the CLI measurement information generated for the first guard band and the second guard band.

Aspect 33: The method of aspect 25, wherein the set of frequency resources is the first downlink subband, the second downlink subband, the uplink subband, the first guard band, and the second guard band, and the one or more types of information includes the CLI measurement information on a per-downlink subband basis, a per-uplink subband basis, and a per guard band basis.

Aspect 34: The method of any of aspects 25 through 33, wherein transmitting the control information comprises: transmitting an index indicative of a combination of the set of frequency resources and the CLI report configuration.

Aspect 35: The method of any of aspects 25 through 34, wherein transmitting the control information comprises: transmitting a cross link interference report configuration, wherein the control information is included in the cross link interference report configuration.

Aspect 36: The method of aspect 24, wherein the CLI measurement resource spans the plurality of frequency resources of the SBFD time resource, the CLI report configuration is for a reporting subband that at least partially overlaps with the first downlink subband, wherein the reporting subband is one or a plurality of CLI measurement subbands that overlap the plurality of frequency resources, the one or more types of information includes a CLI RSSI value.

Aspect 37: The method of aspect 36, wherein the CLI report configuration indicates that only a portion of the reporting subband that overlaps with the one of the first downlink subband or the second downlink subband is to be included in the CLI report that is in accordance with the CLI report configuration.

Aspect 38: The method of aspect 36, wherein the CLI report configuration indicates that only a portion of the reporting subband that overlaps with the one of the first downlink subband or the second downlink subband and any of the first guard band or the second guard band is to be included in the CLI report that is in accordance with the CLI report configuration.

Aspect 39: The method of aspect 24, wherein the CLI measurement resource spans the uplink subband and the first guard band, the CLI measurement information pertains to measurements of only the uplink subband, the one or more types of information includes a CLI RSRP value or an RSSI value, the RSRP value or the RSSI value is associated with the measurements of only the uplink subband.

Aspect 40: The method of aspect 24, wherein the CLI measurement resource spans the uplink subband and the first guard band, the CLI measurement information pertains to measurements of the uplink subband and the first guard band, the one or more types of information includes a CLI RSRP value or an RSSI value, the RSRP value or the RSSI value is a wideband reporting that is associated with the measurements of the uplink subband and the first guard band.

Aspect 41: The method of aspect 24, wherein the CLI measurement resource spans the uplink subband and the first guard band, the CLI measurement information pertains to measurements of the uplink subband and at least a first portion of the first guard band and a second portion of the second guard band, the uplink subband and at least the first portion of the first guard band are associated with a sounding reference signal sequence, the one or more types of information includes a CLI RSRP value or an RSSI value, the RSRP value or the RSSI value is associated with the measurements of the uplink subband and at least the first portion of the first guard band.

Aspect 42: The method of aspect 24, wherein the CLI measurement resource spans the uplink subband and at least the first guard band, the one or more types of information includes a CLI RSRP value or an RSSI value, the RSRP value or the RSSI value is associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

Aspect 43: The method of aspect 24, wherein the CLI measurement resource spans the uplink subband and at least the first guard band, the one or more types of information includes a CLI RSRP value or an RSSI value, the RSRP value or the RSSI value is associated with measurements of only a portion of a reporting subband that overlaps with the uplink subband and at least the first guard band.

Aspect 44: The method of aspect 24, wherein the CLI measurement resource corresponds to a plurality of SRS hopping occasions within the uplink subband, the one or more types of information includes one or more CLI RSRP values, each of the one or more RSRP values is associated with measurements of a respective reporting subband that overlaps with a corresponding one of the plurality of SRS hopping occasions.

Aspect 45: The method of aspect 44, wherein the one or more types of information includes a single RSRP value or RSSI value for a most recent one of the plurality of SRS hopping occasions.

Aspect 46: The method of aspect 44, wherein the one or more types of information includes a plurality of RSRP values or RSSI values, each of the plurality of RSRP values or RSSI values associated with a respective one of the plurality of SRS hopping occasions.

Aspect 47: A first network entity for wireless communication, comprising at least one communication interface; and at least one processor coupled to the communication interface, wherein the first network entity is configured to perform a method of any of aspects 1 through 23.

Aspect 48: An apparatus for wireless communication at a first network entity, comprising at least one means for performing a method of any of aspects 1 through 23.

Aspect 49: A non-transitory computer-readable medium having code for wireless communication stored thereon that, when executed by a first network entity, causes the first network entity to perform a method of any of aspects 1 through 23.

Aspect 50: A first network node for wireless communication, comprising at least one communication interface; and at least one processor coupled to the communication interface, wherein the first network node is configured to perform a method of any of aspects 24 through 46.

Aspect 51: An apparatus for wireless communication at a first network entity, comprising at least one means for performing a method of any of aspects 24 through 46.

Aspect 52: A non-transitory computer-readable medium having code for wireless communication stored thereon that, when executed by a first network entity, causes the first network entity to perform a method of any of aspects 24 through 46.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
at least one communication interface; and
at least one processor coupled to the communication interface, wherein the first network entity is configured to:
receive, from a second network entity, control information that schedules a cross link interference measurement resource that spans at least a portion of a plurality of frequency resources of a subband full duplex time resource, wherein the plurality of frequency resources includes a first downlink subband, an uplink subband, and a first guard band that separates the first downlink subband in frequency from the uplink subband, wherein the control information is indicative of a set of frequency resources of the plurality of frequency resources for measurement within the cross link interference measurement resource, wherein the control information is indicative of a cross link interference report configuration, wherein the cross link interference report configuration is indicative of one or more types of information to be included in a cross link interference report that is in accordance with the cross link interference report configuration;
generate, using a portion of the set of frequency resources that overlaps with a downlink bandwidth part for the first network entity, cross link interference measurement information; and
transmit, to the second network entity, a first report indicative of the cross link interference measurement information, wherein the first report is in accordance with the cross link interference report configuration.

2. The first network entity of claim 1, wherein:
the cross link interference measurement resource spans the plurality of frequency resources of the subband full duplex time resource, and
the one or more types of information includes one or more cross link interference received signal strength indicator (RSSI) values.

3. The first network entity of claim 2, wherein:
the set of frequency resources is the first downlink subband and a second downlink subband included in the plurality of frequency resources and separated from the uplink resource by a second guard band, and
the one or more types of information includes a single cross link interference RSSI value that is an average of the cross link interference measurement information generated for the first downlink subband and the second downlink subband that overlap with the downlink bandwidth part for the first network entity.

4. The first network entity of claim 2, wherein:
the set of frequency resources is the first downlink subband and a second downlink subband included in the plurality of frequency resources and separated from the uplink resource by a second guard band, and
the one or more types of information includes the cross link interference measurement information that overlaps with the downlink bandwidth part for the first network entity on a per-downlink subband basis.

5. The first network entity of claim 2, wherein:
the set of frequency resources is the first downlink subband, a second downlink subband included in the plurality of frequency resources and separated from the uplink resource by a second guard band, the first guard band, and the second guard band, and
the one or more types of information includes a single cross link interference RSSI value that is an average of the cross link interference measurement information generated for the first downlink subband, the second downlink subband, the first guard band, and the second guard band.

6. The first network entity of claim 2, wherein:
the set of frequency resources is the first downlink subband, a second downlink subband included in the plurality of frequency resources and separated from the uplink resource by a second guard band, the first guard band, and the second guard band, and
the one or more types of information includes a first RSSI cross link interference RSSI value generated for the first downlink subband and the first guard band and a second cross link interference RSSI value generated for the second downlink subband and the second guard band.

7. The first network entity of claim 2, wherein:
the set of frequency resources is the first downlink subband, a second downlink subband included in the plurality of frequency resources and separated from the uplink resource by a second guard band, and the uplink subband, and
the one or more types of information includes the cross link interference measurement information on a per-downlink subband or uplink subband basis.

8. The first network entity of claim 2, wherein:
the set of frequency resources is the first downlink subband, a second downlink subband included in the plurality of frequency resources and separated from the uplink resource by a second guard band, and the uplink subband, and
the one or more types of information includes a first cross link interference RSSI value that is an average of the cross link interference measurement information generated for the first downlink subband and the second downlink subband and a second cross link interference RSSI value generated for the uplink subband.

9. The first network entity of claim 2, wherein:
the set of frequency resources is the first downlink subband, a second downlink subband included in the plurality of frequency resources and separated from the uplink resource by a second guard band, the uplink subband, the first guard band, and the second guard band, and
the one or more types of information includes a first cross link interference RSSI value that is an average of the cross link interference measurement information generated for the first downlink subband and the second downlink subband, a second cross link interference RSSI value generated for the uplink subband, and a third cross link interference RSSI value that is an average of the cross link interference measurement information generated for the first guard band and the second guard band.

10. The first network entity of claim 2, wherein:
the set of frequency resources is the first downlink subband, a second downlink subband included in the plurality of frequency resources and separated from the uplink resource by a second guard band, the uplink subband, the first guard band, and the second guard band, and
the one or more types of information includes the cross link interference measurement information on a per-downlink subband basis, a per-uplink subband basis, and a per guard band basis.

11. The first network entity of claim 2, wherein to receive the control information, the first network entity is configured to:
receive an index indicative of a combination of the set of frequency resources and the cross link interference report configuration.

12. The first network entity of claim 2, wherein to receive the control information, the first network entity is configured to:
receive a cross link interference report configuration, wherein the control information is included in the cross link interference report configuration.

13. The first network entity of claim 1, wherein:
the cross link interference measurement resource spans the plurality of frequency resources of the subband full duplex time resource, and
the cross link interference report configuration is for a reporting subband that at least partially overlaps with the first downlink subband, wherein the reporting subband is one of a plurality of cross link interference measurement subbands that overlap the plurality of frequency resources, wherein the one or more types of information includes a cross link interference received signal strength indicator (RSSI) value.

14. The first network entity of claim 13, wherein, to generate the cross link interference measurement information, the first network entity is configured to:
measure cross link interference within only a portion of the reporting subband that overlaps with the first downlink subband.

15. The first network entity of claim 13, wherein, to generate the cross link interference measurement information, the first network entity is configured to:
measure cross link interference within only a portion of the reporting subband that overlaps with the first downlink subband and the first guard band.

16. The first network entity of claim 1, wherein:
the cross link interference measurement resource spans the uplink subband and the first guard band,
the cross link interference measurement information pertains to measurements of only the uplink subband, and
the one or more types of information includes a cross link interference reference signal received power (RSRP) value or a received signal strength indicator (RSSI) value, wherein the RSRP value or the RSSI value is associated with the measurements of only the uplink subband.

17. The first network entity of claim 1, wherein:
the cross link interference measurement resource spans the uplink subband and the first guard band,
the cross link interference measurement information pertains to measurements of the uplink subband and the first guard band, and
the one or more types of information includes a cross link interference reference signal received power (RSRP) value or a received signal strength indicator (RSSI) value, wherein the RSRP value or the RSSI value is a wideband reporting that is associated with the measurements of the uplink subband and the first guard band.

18. The first network entity of claim 1, wherein:
the cross link interference measurement resource spans the uplink subband and the first guard band,
the cross link interference measurement information pertains to measurements of the uplink subband and at least a first portion of the first guard band, wherein the uplink subband and at least the first portion of the first guard band are associated with a sounding reference signal sequence, and
the one or more types of information includes a cross link interference reference signal received power (RSRP) value or a received signal strength indicator (RSSI) value, wherein the RSRP value or the RSSI value is associated with the measurements of the uplink subband and at least the first portion of the first guard band.

19. The first network entity of claim 1, wherein:
the cross link interference measurement resource spans the uplink subband and at least the first guard band, and
the one or more types of information includes a cross link interference reference signal received power (RSRP) value or a received signal strength indicator (RSSI) value, wherein the RSRP value or the RSSI value is associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

20. The first network entity of claim 1, wherein:
the cross link interference measurement resource spans the uplink subband and at least the first guard band, and
the one or more types of information includes a cross link interference reference signal received power (RSRP) value or a received signal strength indicator (RSSI) value, wherein the RSRP value or the RSSI value is associated with measurements of only a portion of a reporting subband that overlaps with the uplink subband and at least the first guard band.

21. The first network entity of claim 1, wherein:
the cross link interference measurement resource corresponds to a plurality of sounding reference signal (SRS) hopping occasions within the uplink subband, and
the one or more types of information includes one or more cross link interference reference signal received power (RSRP) values, wherein each of the one or more RSRP values is associated with measurements of a respective reporting subband that overlaps with a corresponding one of the plurality of SRS hopping occasions.

22. The first network entity of claim 21, wherein:
the one or more types of information includes a single RSRP value or RSSI value for a most recent one of the plurality of SRS hopping occasions.

23. The first network entity of claim 21, wherein:
the one or more types of information includes a plurality of RSRP values or RSSI values, each of the plurality of RSRP values or RSSI values associated with a respective one of the plurality of SRS hopping occasions.

24. A first network entity for wireless communication, comprising:
at least one communication interface; and
at least one processor coupled to the communication interface, wherein the first network entity is configured to:
transmit, to a second network entity, control information that schedules a cross link interference measurement resource that spans at least a portion of a plurality of frequency resources of a subband full duplex time resource that is a downlink symbol, wherein the plurality of frequency resources includes a first downlink subband, an uplink subband, and a first guard band that separates the first downlink subband in frequency from the uplink subband, wherein the control information is indicative of a set of frequency resources of the plurality of frequency resources for measurement within the cross link interference measurement resource, wherein the control information is indicative of a cross link interference report configuration, wherein the cross link interference report configuration is indicative of one or more types of information to be included in a cross link interference report that is in accordance with the cross link interference report configuration; and
receive, from the second network entity, a first report indicative of cross link interference measurement information associated with a portion of the set of frequency resources that overlaps with a downlink bandwidth part for the second network entity, in accordance with the cross link interference report configuration.

25. The first network entity of claim 24, wherein:
the cross link interference measurement resource spans the plurality of frequency resources of the subband full duplex time resource, and
the one or more types of information includes one or more cross link interference received signal strength indicator (RSSI) values.

26. The first network entity of claim 24, wherein:
the cross link interference measurement resource spans the uplink subband and the first guard band,
the cross link interference measurement information pertains to measurements of only the uplink subband, and
the cross link interference report that is in accordance with the cross link interference report configuration includes a cross link interference reference signal received power (RSRP) value or a received signal strength indicator (RSSI) value, wherein the RSRP value or the RSSI value is associated with the measurements of only the uplink subband.

27. The first network entity of claim 24, wherein:
the cross link interference measurement resource spans the uplink subband and the first guard band,
the cross link interference measurement information pertains to measurements of the uplink subband and the first guard band, and
the one or more types of information includes a cross link interference reference signal received power (RSRP) value or a received signal strength indicator (RSSI) value, wherein the RSRP value or the RSSI value is associated with the measurements of the uplink subband and the first guard band.

28. The first network entity of claim 24, wherein:
the cross link interference measurement resource spans the uplink subband and the first guard band,
the cross link interference measurement information pertains to measurements of the uplink subband and at least a first portion of the first guard band, wherein the uplink subband and at least the first portion of the first guard band are associated with a sounding reference signal sequence, and
the one or more types of information includes a cross link interference reference signal received power (RSRP) value or a received signal strength indicator (RSSI) value, wherein the RSRP value or the RSSI value is associated with the measurements of the uplink subband and at least the first portion of the first guard band.

29. The first network entity of claim 24, wherein:
the cross link interference measurement resource spans the uplink subband and at least the first guard band, and
the one or more types of information includes a cross link interference reference signal received power (RSRP) value or a received signal strength indicator (RSSI) value, wherein the RSRP value or the RSSI value is associated with measurements of only a portion of a reporting subband that overlaps with the uplink subband, wherein the reporting subband is one of a plurality of cross link interference measurement subbands that overlap the plurality of frequency resources, and wherein the portion of the reporting subband is a partial cross link interference measurement subband.

30. A method for wireless communication at a first network entity, comprising:
receiving, from a second network entity, control information that schedules a cross link interference measurement resource that spans at least a portion of a plurality of frequency resources of a subband full duplex time resource, wherein the plurality of frequency resources includes a first downlink subband, an uplink subband, and a first guard band that separates the first downlink subband in frequency from the uplink subband, wherein the control information is indicative of a set of frequency resources of the plurality of frequency resources for measurement within the cross link interference measurement resource, and wherein the control information is indicative of a cross link interference report configuration, wherein the cross link interference report configuration is indicative of one or more types of information to be included in a cross link interference report that is in accordance with the cross link interference report configuration;
generating, using a portion of the set of frequency resources that overlaps with a downlink bandwidth part for the first network entity, cross link interference measurement information; and
transmitting, to the second network entity, a first report indicative of the cross link interference measurement information, wherein the first report is in accordance with the cross link interference report configuration.

31. A method for wireless communication at a first network entity, comprising:
transmitting, to a second network entity, control information that schedules a cross link interference measurement resource that spans at least a portion of a plurality of frequency resources of a subband full duplex time resource that is a downlink symbol, wherein the plurality of frequency resources includes a first downlink subband, an uplink subband, and a first guard band that separates the first downlink subband in frequency from the uplink subband, wherein the control information is indicative of a set of frequency resources of the plurality of frequency resources for measurement within the cross link interference measurement resource, and wherein the control information is indicative of a cross link interference report configuration, wherein the cross link interference report configuration is indicative of one or more types of information to be included in a cross link interference report that is in accordance with the cross link interference report configuration; and
receiving, from the second network entity, a first report indicative of cross link interference measurement information associated with a portion of the set of frequency resources that overlaps with a downlink bandwidth part for the second network entity, in accordance with the cross link interference report configuration.
